(19) United States
(12) Patent Application Publication
(10) Pub. No.: US 2011/0238586 A1
(43) Pub. Date: Sep. 29, 2011

(54) System, method and computer program for registering, tracking and communicating with real estate clients

(76) Inventor: Donovan Mainville, Meriden, CT (US)

(21) Appl. No.: 13/075,168

(22) Filed: Mar. 29, 2011

Related U.S. Application Data
(60) Provisional application No. 61/318,760, filed on Mar. 29, 2010.

(51) Int. Cl. G06Q 50/00; G06F 17/30

(52) U.S. Cl. 705/313; 707/736; 707/E17.044

(57) ABSTRACT

A system, method, and computer program for creating a database and registering, tracking, and communicating with potential real estate buyers who visit an open house showing or are interested in a particular listing. The computer program executes on a laptop computer in a user friendly configuration at the open house where potential buyers, upon arrival, register by entering their information into the database via a software interface controlled by the program. Various administrative tools are available to the host real estate agent to follow-up, track and communicate with the potential buyer and/or his realtor. The potential buyer's real estate preferences are stored in the database so as to facilitate alerts and communications by the agent to the buyer regarding the status of the open house listing or other listings. The program also promotes periodic communication by the host agent with buyers over the years so as to generate future listings.

### CROSS REFERENCES TO RELATED APPLICATIONS

This non-provisional patent application claims a priority benefit to U.S. Provisional Application No. 61,318,760 entitled “Realtor Database and Registry for Open House Visitation” filed in the United States Patent and Trademark Office on Mar. 29, 2010 by a common Inventor to this instant application, Donovan Mainville. Further the above named Provisional Application is hereby incorporated by reference.

### STATEMENT REGARDING FEDERALLY SPONSORED RESEARCH

Not Applicable

### REFERENCE TO APPENDIX

Not Applicable

### FIELD OF THE INVENTION

This invention relates to methods, computing systems and software programs for creating an electronic database of clients who visit or show interest in a particular real estate listing.

### BRIEF SUMMARY OF THE INVENTION

This cross-platform compatible Adobe Air program is installed on mobile devices and computers. I call it the “Open House Assistant” and it is a digital registry for Real Estate Agent's hosting an open house. As visitors arrive and register, their information is entered, sorted and stored within the program. The Host Agent, once the open house is over, can save the collected registry data to their local hard drive as a CSV file, or comma delimited list. The program can also be used to, send E-Mail, update Social Networks, save contacts for upload to local and internet based address books, and exportation of the collected information to a variety of file formats.

Once the program has been installed, when executed, the program starts in a window and is immediately set to Full Screen Mode. The “Host User”, the real estate agent hosting the open house, navigates to the Host User Section (FIG. 1)

### BACKGROUND OF THE INVENTION

Realtors conduct ‘open houses’ as a primary means to showcase a particular property and attract buyers. Such promotions involve a large investment of time, personnel, finances and other resources to be a success. The fruit of such labors is the arrival on scene of an Open House Visitor or potential buyer. It is vitally important to the real estate agent's livelihood to ‘capture’ as much information as possible about this buyer, not only factual information such as name and contact information, but other key information, such as the buyer's target home preferences that may assist the real estate agent in closing a deal with this particular buyer. Historically this was all done on paper with a ‘Visitor Log’. This method is fraught with many issues such as physically transferring the information back to the main office, and transcribing it into electronic form. Paper can be misplaced or lost; visitors' handwriting can be impossible to read at times. This invention solves many of these problems.

### OBJECTS AND ADVANTAGES

The primary purpose of this invention is to facilitate a real estate agent's data collection and use thereof of information on potential real estate buyers who come to an open house or register for information regarding real estate for sale.

Accordingly, several objects and advantages of my invention are:

(a) to provide an easy means for an open house visitor to register his personal information with the open house agent;

(b) to provide an electronic database of open house visitors to the real estate agent for future communication with the potential buyers;

(c) to provide a real estate agent with an easy means of collecting personal data of interested potential buyers;

(d) to provide a real estate agent with leads to match up with other or future listings; and

(e) to provide an electronic user interface that will run on multiple platforms including laptops, cell phones and other mobile devices so a potential buyer may easily register his interest in real estate for sale.

Further objects and advantages of my invention will become apparent from a consideration of the drawings and ensuing description.

### BRIEF DESCRIPTION OF THE DRAWINGS

FIG. 1 is a computer screenshot of the Host User Menu;

FIG. 2 is a computer screenshot of the Registered User input fields;

FIG. 3 is a computer screenshot of the Program Reset control panel;

FIG. 4 is a computer screenshot of the More Information panel;

FIG. 5 is a computer screenshot of the Exit Options control panel;

FIG. 6 is a computer screenshot of the Action Status panel;

FIG. 7 is a computer screenshot of the Agent Comments window;

FIG. 8 is a computer screenshot of the Client Database window;

FIG. 9 is a computer screenshot of the Client Profile window;

FIG. 10 is a computer screenshot of the Selection Edit window;

FIG. 11 is a computer screenshot of the Background Music Setup window;

FIG. 12 is a computer screenshot of the Screen Saver Options window;

FIG. 13 is a computer screenshot of the E-mail Manager Tab window;

FIG. 14 is a computer screenshot of the Automated E-mails window;

FIG. 15 is a computer screenshot of the E-mail Log window;

FIG. 16 is a computer screenshot of the E-mail Window window;

FIGS. 17A, 17B are computer screenshots of the Display Manager Tab window;

FIG. 18 is a computer screenshot of the Data Collection Manager Tab window;

FIG. 19 is a computer screenshot of the Field Order Edit window;

FIG. 20 is a computer screenshot of the Selection Edit window;

FIGS. 21A, 21B, 21C are computer screenshots of the E-Mail Window window;

FIGS. 22A, 22B are computer screenshots of the Output Tab window;

FIGS. 23A, 23B are computer screenshots of the Select Form window;

FIG. 24 is a computer screenshot of the Visitor Startup Data Form window;

FIG. 25 is a computer screenshot of the Agent Access Menu window;

FIG. 26 is a computer screenshot of the Visiting Agent Login window;

FIG. 27 is a computer screenshot of the No Rep Data Form 1 window;

FIG. 28 is a computer screenshot of the No Rep Data Form 2 window;

FIG. 29 is a computer screenshot of the No Rep Data Review window;

FIG. 30 is a computer screenshot of the Rep'd Data Form window;

FIG. 31 is a computer screenshot of the Rep'd Data Review window;

FIG. 32 is a block diagram showing the functional structure of the Host Agent Section; and

FIG. 33 is a block diagram showing the functional structure of the Visitor Input Section.

### DETAILED DESCRIPTION OF THE EMBODIMENTS

Host User Section

This section provides the “Host User”, the Individual hosting the Open House, access to the inner workings and settings of the OHA program. This section is not used or seen by the public attending the Open House. All program settings are controlled within this section.

Host User Menu

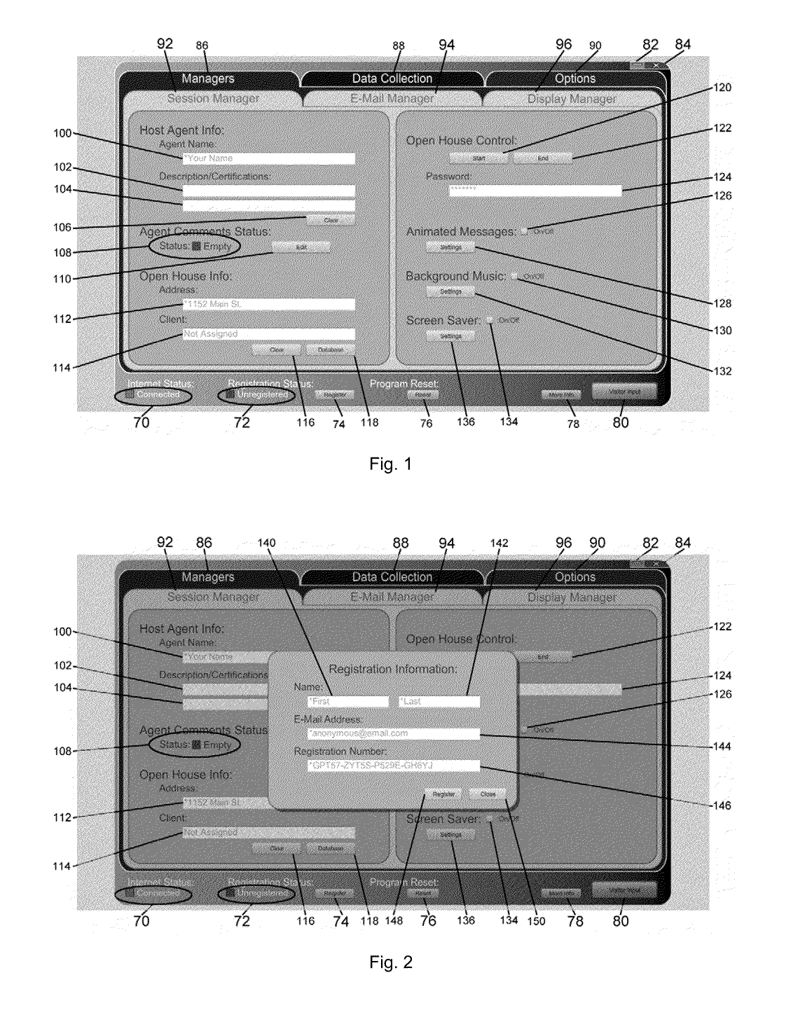

(Now referring to FIG. 1)

Contained Elements: 70-90

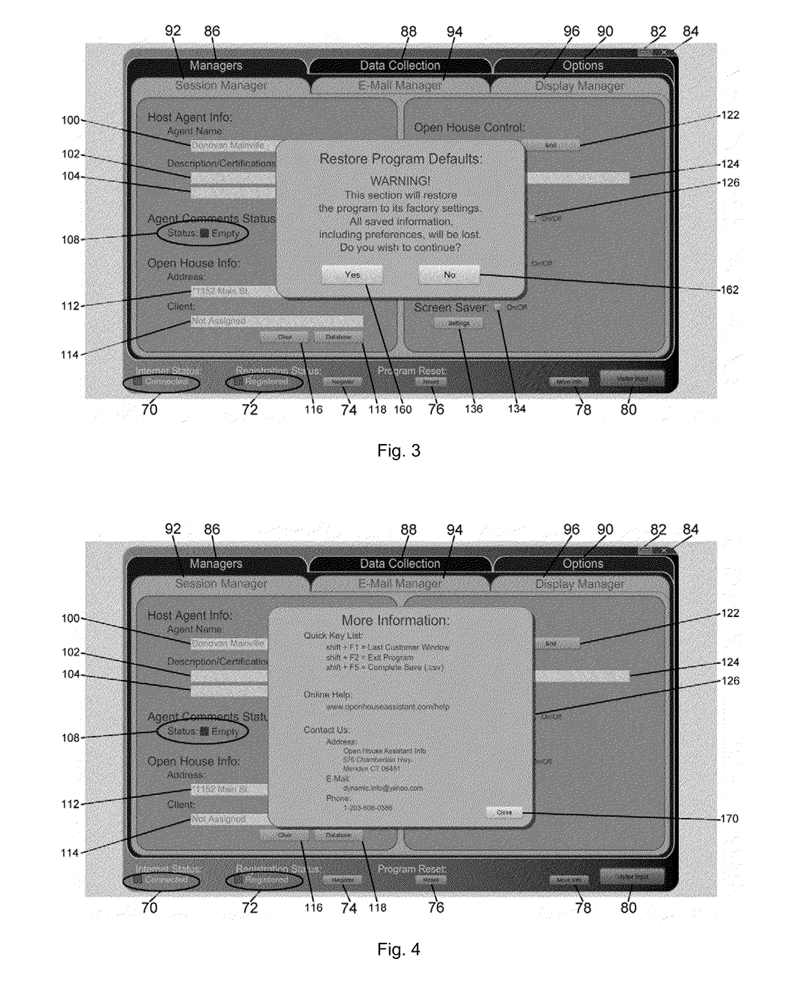

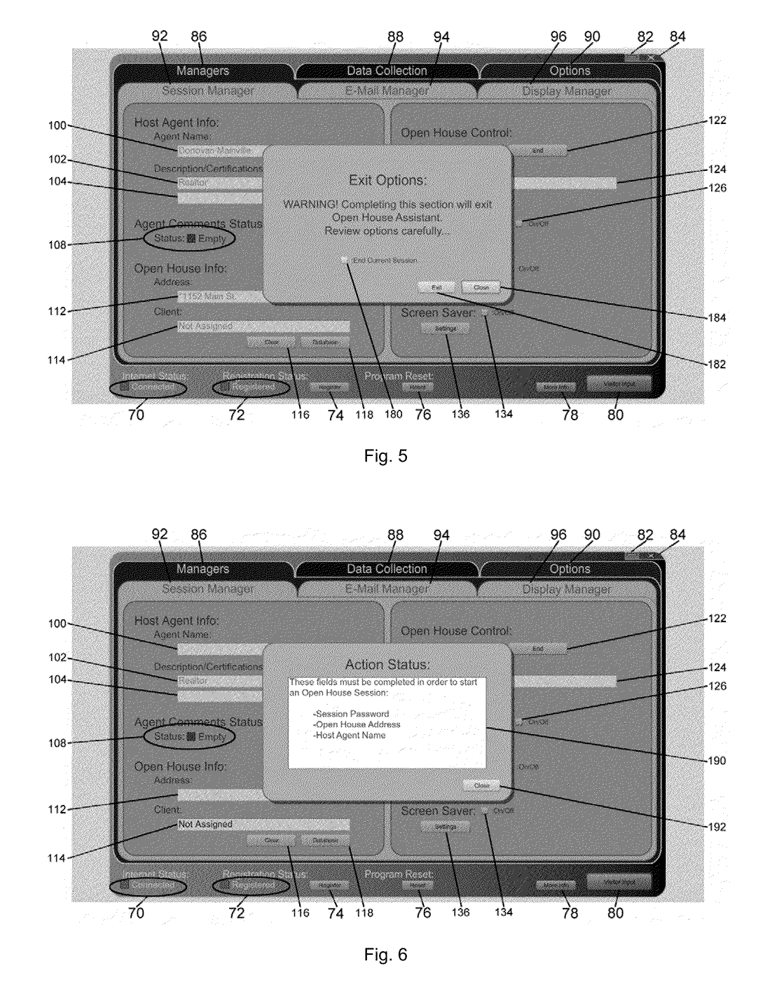

Host User Menu contains three main tabs:
Managers (86):
   Contains settings pertaining to Visitor Input Section.
Data Collection (88):
   Displays and manipulates the visitor entries collected from the Open House.
Options (90):
   Contains settings and controls for informing Visitors and Customers.
Secondary-Controls accessible within this menu include:
   Registration: (FIG. 2)
   Program Reset: (FIG. 3)
   More Info: (FIG. 4)
   Exit Options: (FIG. 5)

Host User Menu Sub-Titles and Elements

Sub-Title Elements:
Internet Status Indicator (70):
   Internet connection status is determined by monitoring the URL address of the E-Mail server, and displayed by the indicators text field and color element. The monitor is started on program initialization and runs infinitely.
      Internet Connection Display States
         True displays “Connected”.
         False displays “Disconnected”.
This element is not selectable or tab enabled.

Registration Status Indicator (72):
The current Registration of the program is displayed by the indicators text field and color element. This status is updated on Program Initialization and Registration completion.
   Registration Display States
      True displays “Registered”.
      False displays “Unregistered”.
This object is not selectable or tab enabled.
Register Button (74):
   When selected:
      The “Registration” symbol and elements are added to the stage (FIG. 2).
      Focus is set to the 150.
   This element is tab enabled.

Program Reset:
Program Reset Button (76):
   When selected:
      The “Program Reset” symbols and elements are added to the stage (FIG. 3).
      Focus is set to 162.
   This element is tab enabled.

Miscellaneous Elements:
Exit Button (84):
   When selected:
      The “Exit Options” symbols and objects are added to the stage (FIG. 5).
      Focus is set to 184
   This element is tab disabled.
Display Change Button (82):
   If the program is in Full Screen Mode, when selected:
      The program is set to NORMAL display state.
   If the program is in Normal Mode, when selected:
      The program is set to FULLSCREEN display state.
   This element is tab disabled.
More Info Button (78):
   When selected:
      The “More Info” window is added to the stage (FIG. 4).
      Focus is set to 170.
   This object is tab enabled.
Visitor Input Button (80):
   If an “Open House Session” is “Active” and 124 contain a valid entry, when selected:
      All Host Input Section objects are removed from the stage.
      The Visitor Input Section's symbols and objects are added to the stage.
      Host User Defined Settings are uploaded to their corresponding locations within the Visitor Input Section.
      If Screen Saver is set “Active”, the screen saver timer is started.
   Visitor Input Section begins with the “Visitor Startup Data Form”. (FIG. 25).
   Focus is set to 648.
   If an “Open House Session” is not “Active” and/or 124 is invalid, when selected:
      The “Action Status Window” symbol and objects (FIG. 5) are added to the stage, displaying the deficiencies that need to be remedied in order to enter the “Visitor Input Section” in 190.
   This element is tab enabled.

Host Menu Secondary Controls

Registration:

(Now referring to FIG. 2)
Contained Elements: 140-150

With this control the “Registered User” inputs their Name, E-Mail Address, and Registration Number in order to register the program. All fields must be complete and the Registration Number must match the internally defined code for the given “Registered User”.

If all fields are complete and the Registration Number is valid, the “Registration” symbols and objects are removed from the stage. The Registration's stored Boolean value is set to “true” and its status is updated in the “Host User Menu” (FIG. 1). If there are any missing fields or the Registration Number is invalid, the “Action Status Window” symbol and objects are added to the stage, displaying the deficiencies that must be changed or completed in order to register. Program registration must be successful in order to save collected data or send e-mails.

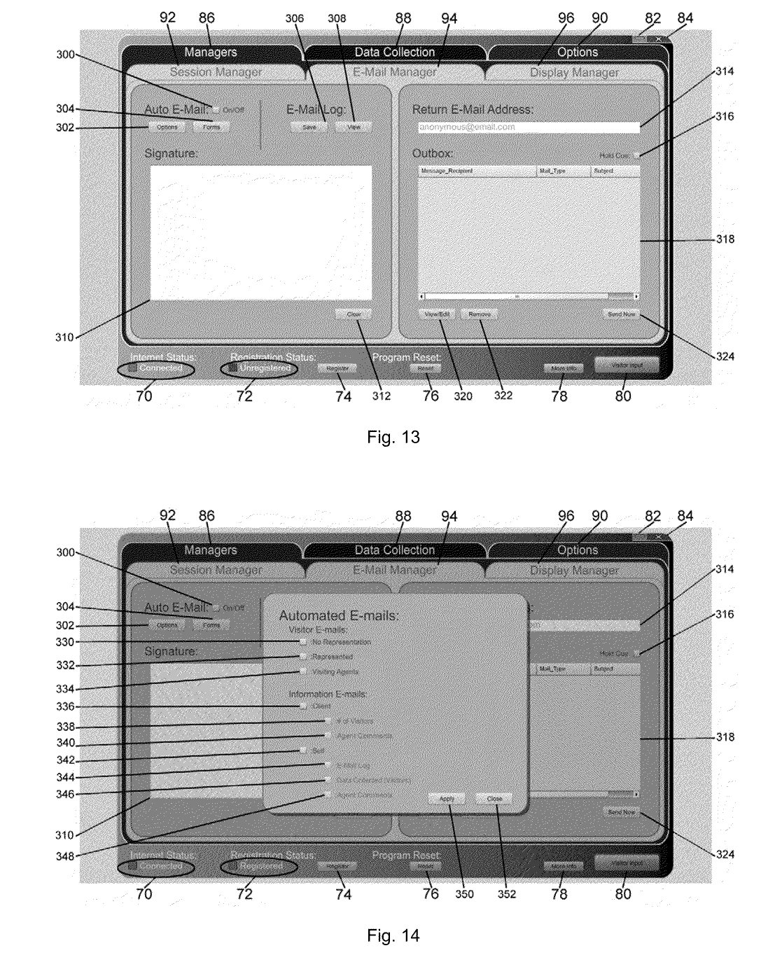

Once registration is complete, the Registered User's name is stored to a Shared Object and applied to element 100 (Session Manager—FIG. 1). Their registered Email address is stored to a Shared Object and applied to element 314 (E-Mail Manager—FIG. 13).

Elements:
First Name Text Input (140):
   The user inputs their First Name.
   This element is tab enabled.
Last Name Text Input (142):
   The user inputs their Last Name.
   This element is tab enabled.
E-Mail Text Input (144):
   The user inputs their Email Address.
   This element is tab enabled.
Registration Number Text Input (146):
   The user inputs their valid Registration Number.
   This element is tab enabled.

Register Button (148):
If the necessary Text Input fields contain valid entries, when selected:
   The Registration's stored value is set to true and its status is updated in 72.
   The “Registration” symbols and objects are removed from the stage.
   140 and 142 are saved, combined, and applied to 100.
   144 is saved to a “Shared Object” and applied to 314.
   Focus is set to 80.
If any necessary Text fields contain invalid entries, when selected:
   The “Action Status Window” symbol and objects (FIG. 6) are added to the stage, displaying the deficiencies that need to be remedied in order to complete the registration process in 190.
This element is tab enabled.

Close Button (150):
When selected:
   The “Registration” symbols and elements are removed from the stage.
   Focus is set to 80.
This element is tab enabled.

Program Reset:

(Now referring to FIG. 3)
Contained Elements: 160, 162

The “Program Reset” gives the user the ability to erase all saved settings, and data while restoring the factory default settings.

Elements:
Yes Button (160):
   When selected:
      All stored data and user defined settings are cleared and the default program settings are reloaded.
      The program is then restarted.
   This element is tab enabled.
No Button (162):
   When selected:
      The “Program Reset” symbols and elements are removed from the stage.
      Focus is set to 80.
   This element is tab enabled.

More Info:

(Now referring to FIG. 4)
Contained Elements: 170

The “More Info” window contains the program's Quick Key List, online help web address link, and Contact information.

Objects:
Close Button (170):
   When selected:
      “More Info” symbol and elements are removed from the stage.
      Focus is set to 80.
   This element is tab enabled.

Exit Options:

(Now referring to FIG. 5)
Contained Elements: 180, 182,184.

The “Exit Options” window contains the program's Exit Option.

Elements:
End Current Session Checkbox (180):
   This checkbox sets the “Open House Session” status on exit.
   This element is tab enabled.
Exit Button (182):
   If the “End Current Session Checkbox” is selected, when 182 is selected:
      The “Active Open House Session” is terminated.
      If 336 and/or 342 have been checked by the “Host User”, the emails are created and directed depending on the current Internet Status.
      The program is then terminated.
   If 180 is not selected, when 182 is selected:
      The “Active Open House Session” stays “Active”.
      The program is then terminated.
   This element is tab enabled.
Close Button (184):
   When selected:
      The Exit Options symbols and elements are removed from the stage.
      Focus is set to 80.
   This element is tab enabled.

Program Communication

Action Status:

(Now referring to FIG. 6)

The “Action Status” window displays status messages to the user in 190. These messages provide the user with the information connected to the reporting action. These includes Action Deliveries (Requirements that need to be completed), and Action Description (Reports status of requested action). This window is used within both the Host User Section, and Visitor Input Section.

Elements:
Action Status Information Text Area (190)
   This text area displays action messages to the user.
   This element is not tab enabled.
Action Status Close Button (192)
   When selected:
      The “Action Status” window and elements are removed from the stage. (FIG. 6)
      This element is not tab enabled.

Managers Tab

(Now referring to FIG. 1)

Contained Element: 86.

Managers Tab contains three tabs:
Session Manager (92)
   Contains settings and controls for the Open House Sessions. These options include Visitor's information and experience settings.
E-Mail Manager (94)
   Contains settings and controls for E-Mail related processes, and information.
Display Manager (96)
   Contains settings and controls for manipulating the Visitor Input Section's look and feel.

Manager Elements

Miscellaneous Elements:
Managers Tab Title (86):
   When selected:
      The Manager Tab and Sub-Tabs are brought to the foreground.
   This element is tab enabled.

Know himSession Manager Tab:

(Now referring to FIG. 1)

Contained Elements: 92, 100-136.

This tab contains the controls for the “Open House Session settings”. These controls manipulate the Visiting Users Section only. They have no effect on the Host User Section.

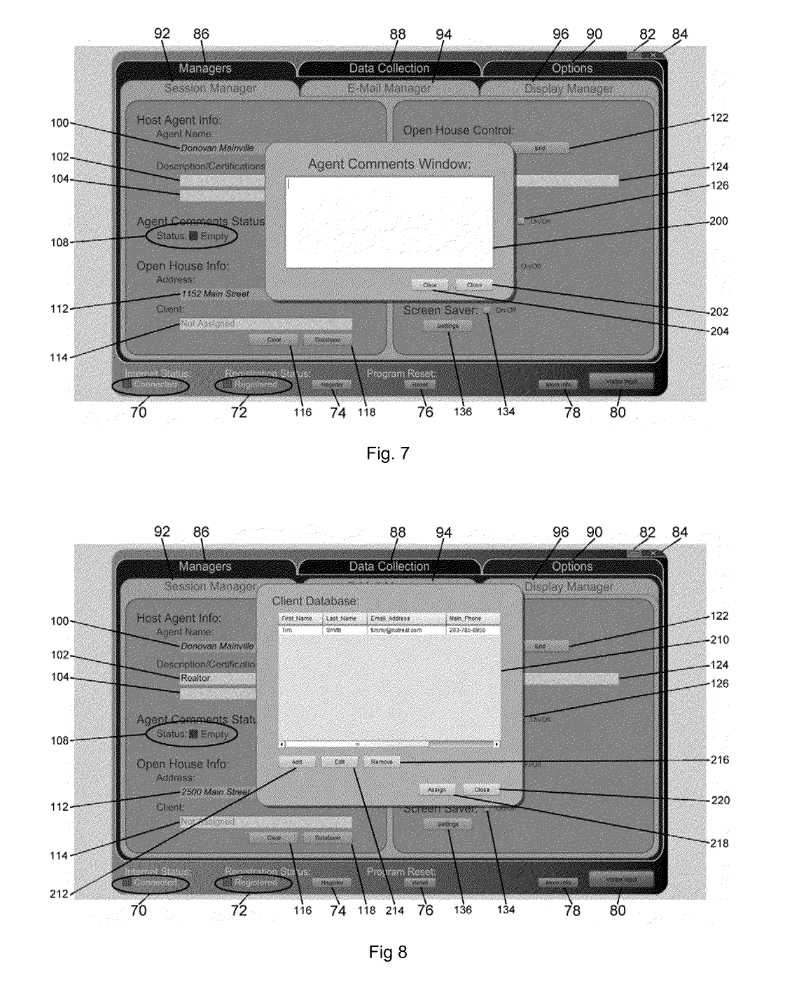

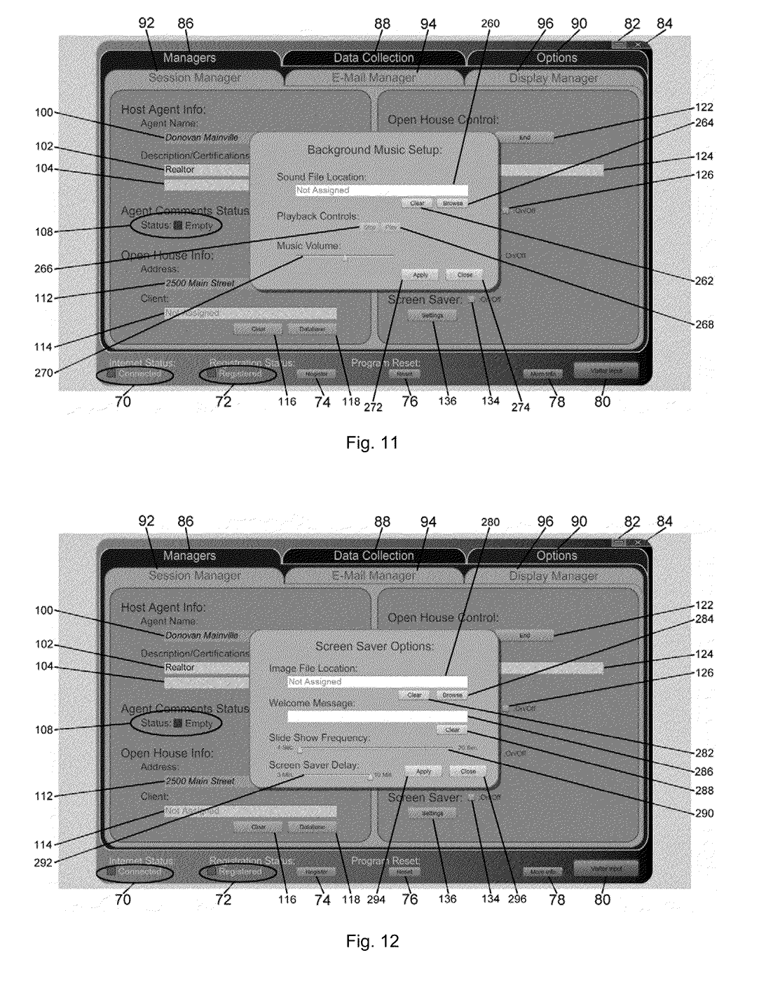

Session Manager's sub-titles include:
Host Agent Info:
   This sub-title contains input fields for defining the Host Agent's Name Certification and Title Description.
Agent Comments Status:
   This sub-title contains controls for accessing the “Agent Comments” controls.
Open House Info:
   This sub-title contains a text input for defining the Open House's address and controls for accessing the “Client Database” controls to define the property's client.
Open House Control:
   This sub-title contains controls for starting and ending an Open House Session.
Background Music:
   This sub-title contains controls for turning the background music on and off, and for accessing the “Background Music Set-up” controls for the Open House Session.
Animated Messages:
   This sub-title contains controls for accessing the “Animated Message” controls for the Open House Session. The user can save messages to be displayed to visitors while they register.
Screen Saver:
   This sub-title contains controls for turning the Screen Saver on and off, and for accessing the “Screen Saver” controls for the Open House Session.
Secondary Controls accessible within this Tab include:
   Agent Comments: (FIG. 7)
   Client Database: (FIG. 8)
   Background Music Set-up: (FIG. 11)
   Screen Saver Options:(FIG. 12)

Session Manager Sub-Titles and Elements

Sub-Title Elements:
Host Agent Info:
   Host Agent Name Text Input (100):
      “Host User” inputs their Full Name.
      When a session is “Activated”:
         This text field value is stored as a Shared Object which is displayed in 614.
      This field must contain a valid entry in order to start an ‘Open House Session“.
      This component instance is tab enabled.
   Description/Certifications Text Input (102, and 104):
      “Host User” inputs their Title and Certifications Information.
      Each line is restricted to 26 Characters.
      When a session is “Activated”:
         102 and 104′s values are stored as Shared Objects.
         102 displays in 616.
         104 displays in 618.
      These elements are tab enabled.
Open House Info:
   Address Text Input (112):
      “Host User” inputs the Open House's Street Address.
      When a session is “Activated” this text field value is stored as a Shared Object and is displayed in 622.
      This field must contain valid entry in order to start an ‘Open House Session“.
      This element is tab enabled.
   Open House Client Text Field (114):
      Displays the Client assigned to the Open House Session from the “Client Profile” selected in 210.
      This value is updated when the Client Profile is assigned.
         Client Profile Assigned:
         True displays the Assigned Client's full name.
         False displays “Not Assigned”
      This element is not selectable or tab enabled.
   Clear Button (116):
      When selected:
         114 displays “Not Assigned”.
         “Client Profile” assigned is false, status is stored.
      This element is tab enabled.
   Client Database Button (118):
      When selected:
         The “Client Database” window and elements are added to the stage (FIG. 8)
         Focus is set to 220.
      This element is tab enabled.
Agent Comments Status Indicator (108):
   This text field and color element change depending on the stored “Agent Comments Status” value.
      Internet Connection Display States
         True displays “Connected” and “Green”.
         False displays “Disconnected” and “Red”.
   This element is not selectable or tab enabled.
Agent Comments Edit Button (110):
   When selected:
      The “Agent Comments” window and elements are added to the stage. (FIG. 7)
      Focus is set to 204.
   This element is tab enabled.
Open House Control:
   Session Start Button (120):
      If 100, 112, and 124, contain valid entries, when selected:
         The Open House Session is set “Active” and 120 are disabled.
      If 100, 112, or 124 contain invalid entries, when selected:
         The “Action Status Window” symbol and elements are added to the stage, displaying the deficiency or deficiencies that need to be remedied in order to activate the “Open House Session”, in 190. (FIG. 6)
      This element is tab enabled.
   Session End Button (122):
      When selected:
         The “Active Open House Session” is terminated.
         The “Action Status Window” symbol and elements are added to the stage, displaying in 190 a notification to the “Host User” that the session has been terminated (FIG. 6).
         If 336 and/or 342 have been checked by the “Host User”, the emails are created and directed depending on the current Internet Status.
         Internet Status:
         True directs all e-mails to the PhP Email Server via the internet.
         False directs all e-mails to 318.
         200 and its stored value is cleared and 108 is set to “Empty”.
      This element is tab enabled.
   Password Text Input (124):
      “Host User” inputs their Open House Session Password.
         This field must contain a valid entry in order to start an ‘Open House Session“.
         When a session is “Activated” this value is stored to a shared object.
         This value is referenced when the “Host User” choices to re-enter the Host User Section from the Visitors Input Section.
      This element is tab enabled.

Animated Messages:
Animated Message On/Off Checkbox (126):
   Allows the “Host User” to turn the “Animated Messages” (650, 712, 758, and 818) on or off.
      When changed:
      Its value is stored to a shared object.
      Animated Messages On/Off Data:
      True turns the messages on and displays a checkmark.
      False turns the messages off and displays no checkmark.
      This value is referenced when the program initializes and is applied to 126.
   This element is tab enabled.
Animated Messages Settings Button (128):
   When selected:
      The “Form Manager Tab” elements are brought to the foreground of the stage. (FIG. 23B)
      Focus is set to 560.
      560 is set to “Animated”.
   This element is tab enabled.
Background Music:
   Background Music On/Off Checkbox (130):
      Allows the “Host User” to turn background music, during the Visitor Input Section, on or off.
         When selected:
         Its value is stored to a shared object.
         Background Music On/Off Data:
         True turns music on and displays a checkmark.
         False turns music off and displays no checkmark.
         This value is referenced when the program initializes and applied to 130.
      This component is tab enabled.
   Background Music Settings Button (132):
      When selected:
         The “Background Music Setup” window and elements are added to the stage.
         Focus is set to the 274.
      This element is tab enabled.
Screen Saver:
   Screen Saver On/Off Checkbox (134):
      Allows the “Host User” to turn the Screen Saver, during the Visitor Input Section, on or off.
         When selected:
         Its value is stored.
         Background Music On/Off Data:
         True turns the Screen Saver on and displays a checkmark.
         False turns the Screen Saver off and displays no checkmark.
         This value is referenced when the program initializes and applied to the checkbox.
      This component is tab enabled.
   Screen Saver Settings Button (136):
      When selected:
         The “Screen Saver Options” window and elements are added to the stage.
         Focus is set to 296
      This element is tab enabled.
Miscellaneous Elements:
   Session Manager Tab Title (92):
      When selected:
         The Session Manager Tab and elements are brought to the foreground.
      This element is tab enabled.

Session Manager Secondary Controls

Agent Comments Window:

(Now referring to FIG. 7)
Contained Elements: 200-204

The “Agent Comments Window” provides the “Host User” with the ability to save their comments on the Open House. This stored value is applied to appropriate “Auto-Emails” when selected under the “Auto-Email Options Control” and is cleared with 204, or when an “Active Open House Session” is ended.
Elements:
   Agent Comments Text Input (200):
      “Host User” inputs Comments on the Open House.
      When changed:
         200′s value is stored.
         108 displays “Saved” and Green.
      This element is tab enabled.
   Clear Button (202):
      When selected:
         200 and its stored value are cleared.
         108 displays “Empty” and Red.
      This element is tab enabled.
   Close Button (204):
      When selected:
         The “Agent Comments Control” symbols and elements are removed from the stage.
         Focus is set to 80.
      This element is tab enabled.

Client Database:

(Now referring to FIG. 8)
Contained Elements: 210-220

The “Client Database Control” provides the “Host User” with the ability to store their “Client Information” for use during future “Open House Sessions”. When this database is opened the stored client profiles are retrieved and displayed for the “Host User” in the “Stored Profiles Data Grid”.

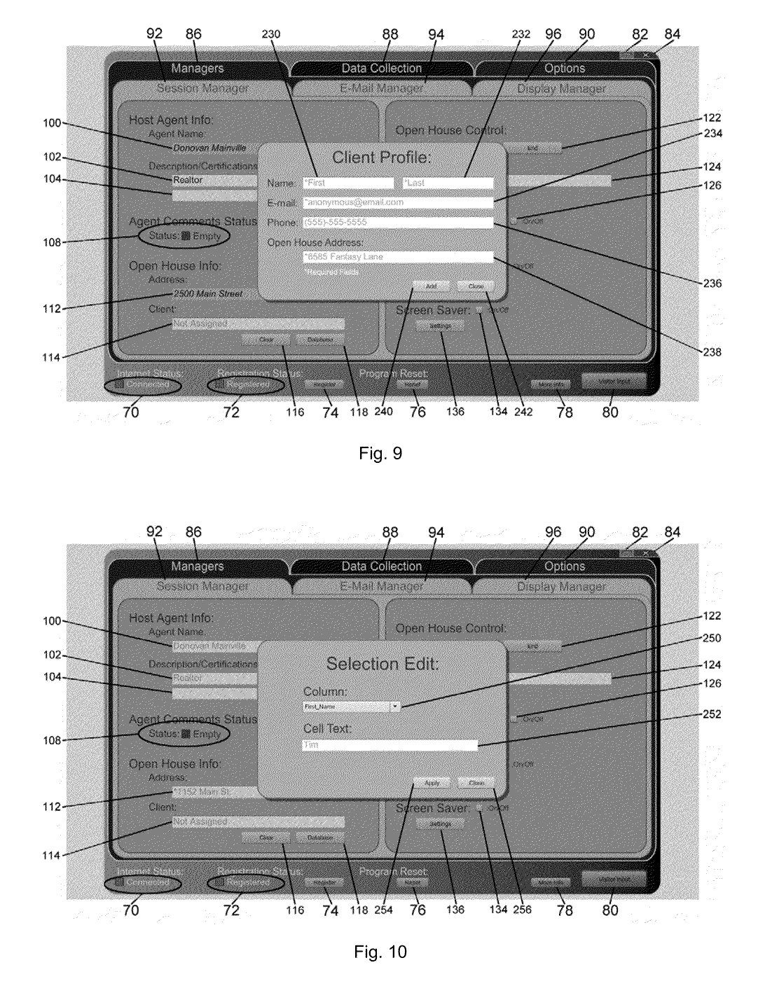

Elements:
Client Profiles Data Grid (210):
   This data grid displays the stored Client Profiles currently contain within the program's Shared Objects.
   This element is tab enabled.
Client Add Button (212):
   When selected:
      The “Client Database” symbol and elements are removed from the stage, and the “Client Profile” window and elements are added to the stage. (FIG. 9)
      Focus is set to 242.
   This element is tab enabled.
Client Edit Button (214):
   When selected:
      The “Client Database” window and elements are removed from the stage, and the “Selection Edit” symbol and elements are added to the stage. (FIG. 10)
      Focus is set to the 256.
   This element is tab enabled.
Client Remove Button (216):
   When selected:
      The selected “Client Profile” is removed from 210, and is erased from its stored location.
   This element is tab enabled.
Client Assign Button (218):
   When select:
      The selected “Client Profile” is applied to Open House Session.
         The Client's name is set and displayed in 114.
         The Client's address is set and displayed in 112, thusly being applied to the “Visitor Startup Page” (FIG. 25).
         The Client's email address is set and used for the “Client Auto Email Address”.
      Using a looping statement the entire Client Database is updated and saved to stored objects for future retrieval.
   Focus is set to the 80.
   This element is tab enabled.
Client Database Close Button (220):
   When selected:
      The “Client Database” window and elements are removed from the stage.
      Focus is set to 80.
      Using a looping statement the entire Client Database is updated and saved for future retrieval.
   This element is tab enabled.

Client Profile:

(Now referring to FIG. 9)
Contained Elements: 230-242

The “Client Profile Control” provides the “Host User” with the ability to store new “Client Profile Information” to the “Client Database”.

Elements:
First Name Text Input (230):
   “Host User” inputs the Client's first name.
   This is a required field.
   This element is tab enabled.
Last Name Text Input (232):
   “Host User” inputs the Client's Last Name.
   This is a required field.
   This element is tab enabled.
E-Mail Address Text Input (234):
   “Host User” inputs the Client's Email Address.
   This is a required field.
   This element is tab enabled.
Phone Text Input (236):
   “Host User” inputs the Client's Phone Number.
   This is not a required field.
   This element is tab enabled.
Open House Address Text Input (238):
   “Host User” inputs the Client's Open House Address.
   This is a required field.
   This element is tab enabled.
Add Profile Button (240):
   If 230, 232, 234, and 238 all contain valid entries, when selected:
      The Client Profile is stored and is addted to “Client Profiles Data Grid”.
      The “Client Profile” window and elements are removed from the stage, and the “Client Database” symbols and elements are added to the stage (FIG. 8).
      Focus is set to the 220.
   If any required Text fields contain invalid entries, when selected:
      The “Action Status Window” symbol and elements (FIG. 5) are added to the stage, displaying the deficiencies that need to be remedied in order to save the current client profile, in 190.
   This element is tab enabled.
Client Profile Close Button (242):
   When selected:
      The “Client Profile” window and elements are removed from the stage, and the “Client Database” window and elements are added to the stage (FIG. 8).
      Focus is set to the 220.
   This element is tab enabled.

Client Profile Selection Edit:

(Now referring to FIG. 10)
Contained Elements: 250-256

The Client Profile Selection Edit Control” provides the “Host User” with the ability to edit a stored “Client Profile” from the “Client Database”.

The “Client Database Column Headers” are loaded into the “Column” Combo Box.

Elements:
Column Combo Box (250):
   When changed:
      The corresponding value contained within the selected “Client Profile” in 210 is displayed in 252.
   This element is tab enabled.
Cell Text—Text Input (252):
   Initially displays the current value for the selected title of element 250.
   “Host User” inputs a new value for the displayed 250 selection.
   This element is editable and tab enabled.
Apply Button (254):
   When selected:
      252 is updated. The current profile value for the selected column in 250 is updated to the selected profile in 210 with the value in 252.
      The Client Profile is updated within 210 and stored internally.
   This element is tab enabled.
Close Button (256):
   When selected:
      The “Client Profile Selection Edit Control” window and elements are removed from the stage.
      Focus is set to 220.
   This element is tab enabled.

Background Music Setup:

(Now referring to FIG. 11)
Contained Elements: 260-274

The “Background Music Setup Control” provides the “Host User” with the ability to add background music to the “Open House Session”. If Background Music is turned on, when the “Host User” enters the Visitor Input Section, the Music Files defined by the user begin to play, in order of selection. Acceptable music file formats include: *.wav and *.mp3.

Elements:
Music File Location Text field (260):
   This text field displays the assigned music file location on the Hard Drive. If no files are defined 260 displays “Not Assigned”.
   This element is not selectable or tab enabled.
Clear Button (262):
   When selected:
      260 is set to “Not Assigned”.
      264 is enabled.
      266 and 264 are disabled.
   This element is tab enabled.
Browse Button (264):
   When selected:
      The “Operating System File Selection” window is opened allowing the “Host User” to select multiple sound files from a local hard drive location.
         Once music files have been selected:
         The files are individually loaded into the program using a looping statement.
         Loader errors are displayed in individual “Action Status” windows (FIG. 6).
         The successfully loaded music file/files hard drive location is displayed in 260.
         The Hard Drive File References for the selected music files are stored to Shared Objects.
      264 is disabled.
      266 and 268 are enabled.
   This element is tab enabled.
Stop Button (266):
   When selected:
      The sound file being played is halted.
   This element is tab enabled.
Play Button (268):
   When selected:
      The displayed sound file is loaded and played.
         If one or multiple files are selected the file stored in first position is used for this task.
   This element is tab enabled.
Music Volume Slide Bar (270):
   When changed:
      The slide bar value is saved.
      If the displayed music file is being previewed, its play volume is changed to reflect 270′s value.
   This element is tab enabled.
Apply Button (272):
   If one or more music files have been defined by the “Host User”, when selected:
      The defined music file locations are saved to shared objects, using a looping statement.
      The values of elements 260 and 270 are saved.
      Music playback is stopped.
      The “Background Music Setup” symbols and elements are removed from the stage.
   Focus is set to 80.
   This element is tab enabled.
Close Button (274):
   When selected:
      The “Background Music Setup” symbols and elements are removed from the stage.
      Music playback is stopped.
   Focus is set to 80.
   This element is tab enabled.

Screen Saver Options:

(Now referring to FIG. 12)
Contained Elements: 280-296

The “Screen Saver Options Control” provides the “Host User” with the ability to change “Screen Saver” settings, when engaged during the “Open House Session”. If the “Screen Saver” is turned on, when the “Host User” enters the Visitor Input Section, the “Screen Saver Delay Timer” is started. When the timer runs out, the “Screen Saver Player” symbols and objects are added to the screen. The “Welcome Message” is displayed to arriving visitors, while selected “Screen Saver Images” are displayed one at a time. Displayed Image is changed to the next listed image once the “Slide Show Frequency Timer” has elapsed. Acceptable image file formats include: *.bmp, *.jpg, and *.gif.

Elements:
Image File Location Text Field (280):
   This text field displays the assigned image file location on the Hard Drive.
      If no files are defined 280 displays “Not Assigned”.
      Selected images are displayed when screen saver is engaged.
   This element is not selectable or tab enabled.
Clear Button (282):
   When selected:
      280 is set to “Not Assigned”.
   This element is tab enabled.
Browse Button (284):
   When selected:
      The “Operating System File Selection” window is opened allowing the “Host User” to select one or multiple image files from a local hard drive location.
         Once image files have been selected:
         The files are individually loaded into the program using a looping statement.
         Loader errors are displayed in individual “Action Status” windows. (FIG. 6)
         The successfully loaded image file/files hard drive location is displayed in 280.
   This element is tab enabled.
Welcome Message Text Input (286):
   “Host User” inputs a message to be displayed to “Visitors” when the Screen Saver is engaged.
   This element is editable and tab enabled.
   Message is displayed when screen saver is engaged.
Welcome Message Clear Button (288):
   When selected:
      The all text contained within 288 is erased.
   This component instance is tab enabled.
Slideshow Frequency Slide Bar (290):
   This slide bar sets the amount of time that needs to pass before the slide show is changed to the next image.
   When changed:
      The slide bar value is updated.
         This stored value is referred to by the “Screen Saver Player” once the screen saver delay timer has elapsed. Every time the Slideshow Frequency Slider elapses the next listed image file is loaded into 690.
   This element is tab enabled.
Screen Saver Delay Slide Bar (292):
   This slide bar sets the amount of time that needs to pass before the Screen Saver is engaged.
   When changed:
      The slide bar value is updated.
         This value is applied to the screen saver delay timer. This timer is triggered when the Visitor Input Section is entered and every time the mouse is moved or any keyboard key is pressed by the “User”.
   This element is tab enabled.
Apply Button (294):
   If one or more music files have been defined by the “Host User”, when selected:
      The defined image file locations are saved, using a looping statement.
      The values of elements 280, 286, 290, and 292 are saved.
      The “Screen Saver Options” symbols and elements are removed from the stage.
   Focus is set to 80.
   This element is tab enabled.
Close Button (296):
   When selected:
      The “Background Music Setup” symbols and elements are removed from the stage.
      Focus is set to the 80.
   This element is tab enabled.

E-Mail Manager Tab:

(Now referring to FIG. 13)
Contained Elements: 94, 300-324

This Manager gives the “Host User” the ability to change E-Mail Settings applied to the program operation.

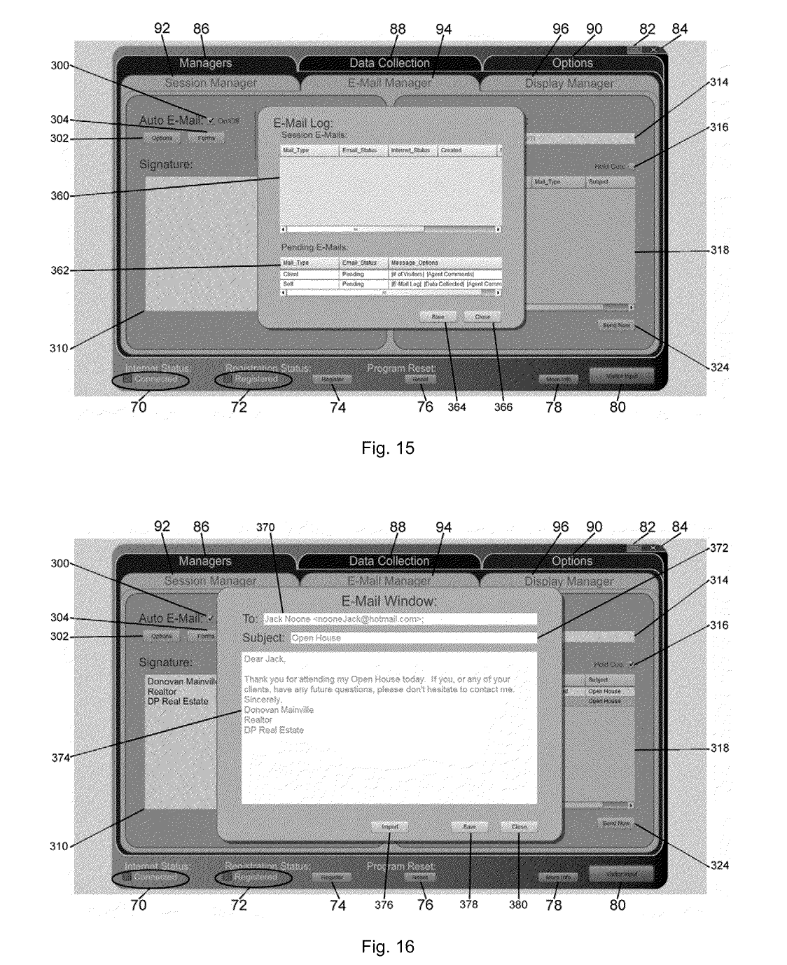

E-Mail Manager's sub-titles include:
Auto E-Mail:
   Gives the “Host User” control for accessing Automated E-Mail Control, Options and Form Edit.
E-Mail Log:
   Gives the “Host User” the ability to view or save the current “E-Mail Log”.
Signature:
   Contains controls for “Host Agent” signature manipulation.
Return E-Mail Address:
   Displays the “Host Agent's” Return E-Mail Address.
Outbox:
   Displays E-Mails in the Outbox cue and gives the “Host User” the ability to manipulate the cue and emails contained within it.
Secondary Controls accessible within this Tab include:
   Automated E-Mails: (FIG. 14)
   E-Mail Los: (FIG. 15)
   E-Mail Outbox View/Edit: (FIG. 16)

Email Manager Sub-Titles and Elements

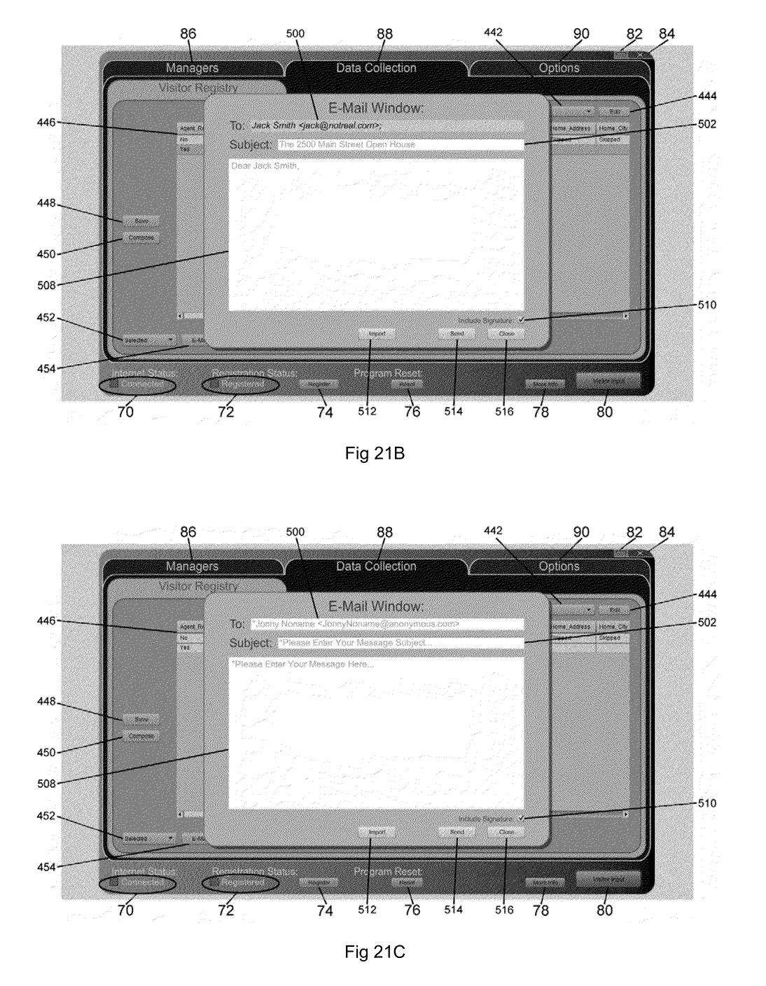

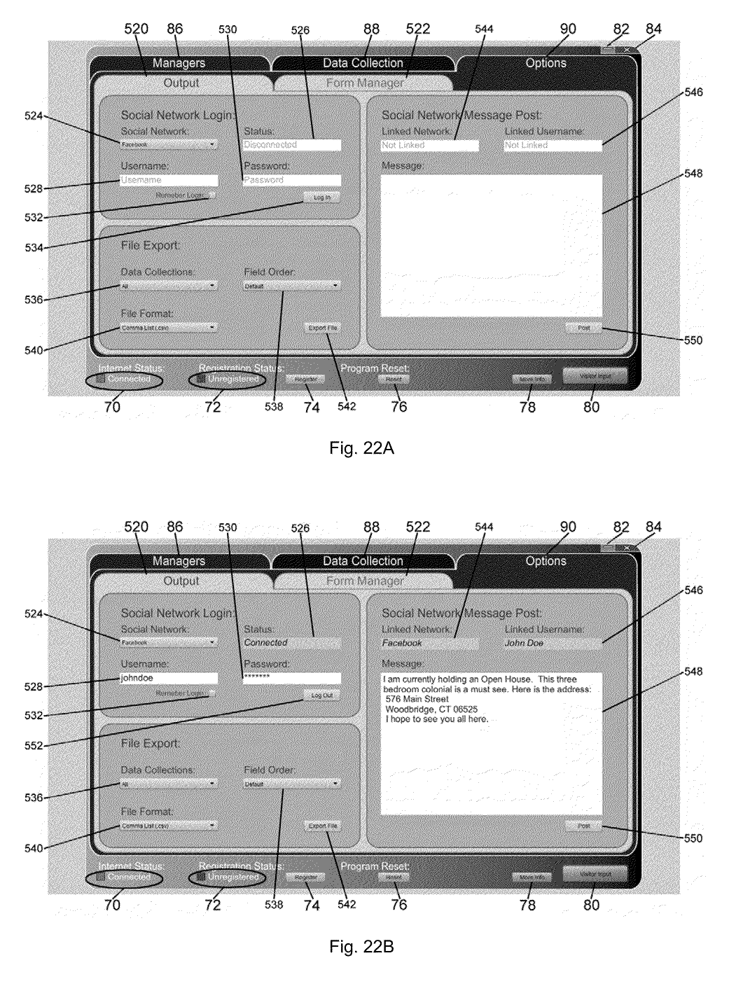

Sub-Title Elements:
Auto E-Mail:
   Auto E-Mail On/Off Check Box (300):
      Allows the “Host User” to turn the creation of all Automated E-Mails on or off.
         When changed:
         Its value is stored to a shared object.
         Auto E-Mail On/Off Data:
         True turns the messages on and displays a checkmark.
         False turns the messages off and displays no checkmark.
         This value is referenced when the program initializes and is applied to 300.
   Auto E-Mail Options Button (302):
      When Selected:
         The “Automated E-Mails” window and elements are added to the stage.
         Focus is set to 352.
      This element is tab enabled.
   Auto E-Mail Forms Button (304):
      When selected:
         The “Form Manager Tab” and elements are brought to the foreground of the stage (FIG. 23A).
         Focus is set to 560.
         560 is set to “E-Mail.”
      These elements are tab enabled.
E-Mail Log:
   E-Mail Log Save Button (306):
      When selected:
         The Log entry from 360 is formatted into a comma delineated string to be saved.
         An operating system save window opens allowing the user to define the file name and hard drive save location.
      This element is tab enabled
   E-Mail Log View Button (308):
      When selected:
         The “E-Mail Log” window and elements are added to the stage (FIG. 21).
         Focus is set to 366.
      This element is tab enabled.
Signature:
   Signature Text Area (310):
      When changed:
         Its value is stored to a “Shared Object.”
         This value is cleared when 312 or 160 are selected.
      This element is tab enabled.
   Signature Clear Button (312):
      When selected:
         310 and its stored value are erased.
      This element is tab enabled.
Return E-Mail Address:
   Return E-Mail Address Text Field (310):
      If 72 displays “Registered”
         310 displays the saved value from 144.
      If 72 displays “Unregistered”
         310 displays “anonymous@email.com.”
      This element is tab enabled.
Outbox:
   Hold Cue Check Box (316):
      Allows the “Host User” to hold all created E-Mails from being sent to the internet.
         When checked:
         All created E-Mails are held in 318.
         When unchecked and internet connection is available:
         E-Mails are sent to the Php E-Mail Handler via the internet.
      This component is tab enabled.
   Outbox Data Grid (318):
      Displays the emails that have been held from the internet.
      Columns include:
         Message Recipient—Message Recipient's name and E-Mail address
         Mail Type—Displays how the program created the E-Mail.
         Auto—Automated E-mail
         Manual—E-mails created using the “E-mail Window.” (FIG. 21A-C)
         Subject—Displays E-mails subject.
         Created—Displays the date and time E-mail was created.
      This component is tab enabled.
   View/Edit Button (320):
      When selected:
         The “Email Outbox View/Edit” window is added to the stage displaying the data from the selected Email in 318.
      This component is tab enabled.
   Remove Button (322):
      When selected:
         The selected Email in 318 is deleted.
         Using a looping statement, the remaining emails in 318 are stored to “Shared Objects.”
      This component is tab enabled.
   Send Now Button (324):
      When selected and the internet connection returns true:
         All emails listed in 318 are stored to “Shared Objects.”
      This component is tab enabled.
Miscellaneous Elements:
   E-Mail Manager Tab Title (94):
      When selected:
         The E-Mail Manager Tab and elements are brought to the foreground.
      This element is tab enabled.

E-Mail Manager Secondary Controls

Automated E-Mails:

(Now referring to FIG. 14)
Contained Elements: 330-352

The “Host User” selects which Automated E-Mails are to be created during and at the conclusion of “Open House Sessions”.

Auto E-Mails sub-titles include:
Visitor E-Mails:
   These check boxes control whether automated e-mails are created for specific visitor groups.
Information E-Mails:
   These check boxes control e-mail creation options for specific collected information to the “Host User” and defined Client.

Automated E-Mails Sub-Titles and Elements

Sub-Title Elements:
Visitor E-Mails:
   No Representation Check Box (330):
      When checked:
         An automated e-mail is created for every registered visitor without representation.
      This element is tab enabled.
   Represented Check Box (332):
      When checked:
         An automated email is created for every visitor with agent representation.
      This element is tab enabled.
   Visiting Agents Check Box (334):
      When checked:
         An automated email is created for every visiting agent to the open house.
      This element is tab enabled.
Information E-Mails:
   Client Check Box (336):
      When checked:
         A standard automated e-mail is created for the assigned client at the end of an “Open House Session.”
      This element is tab enabled.
      Client Auto E-Mail Options:
         # of Visitors Check Box (338):
         When checked:
         The number of visitors to attend the open house is added to the “Client” auto e-mail.
         This element is tab enabled.
         Agent Comments Check Box (340):
         When checked:
         The “Host Agent” comments entered in 200 are added to the “Client” auto e-mail.
         This element is tab enabled.
   Self Check Box (342):
      When checked:
         A standard automated e-mail is created for the “Host Agent” at the end of an “Open House Session.”
      This element is tab enabled.
      Self Auto E-Mail Options:
         E-Mail Log Check Box (344):
         When checked:
         The E-mail Log for the “Open House Session” is added to the auto e-mail to self (Host Agent).
         This element is tab enabled.
         Data Collected (Visitors) Check Box (346):
         When checked:
         All collected “Visitor Data Profile” are added to the “Self” auto e-mail.
         This element is tab enabled.
         Agent Comments Check Box (348):
         When checked:
         The agent comments entered in 200 are added to the “Self” auto e-mail.
         This element is tab enabled.
Navigation Elements:
   Apply Button (350):
      When selected:
         The values for elements 336-348 are saved.
         The “Automated E-mails” window is removed from view.
      This element is tab enabled.
   Close Button (352):
      When selected:
         The “Automated E-mail” window is removed from view.
      This element is tab enabled.

E-Mail Log:

(Now referring to FIG. 15)
Contained Elements: 360-366

Whenever an e-mail is created by the program, a corresponding entry is created in 360 with the created e-mails details. Auto E-mails to be completed on “Open House Session” termination are displayed in 362.

Elements:
Session E-Mails Data Grid (360):
   Displays all e-mails created during the “Open House Session.”
   Columns include:
      Mail Type
         Displays how the e-mail was created.
         Auto—Automated E-mail.
         Manual—E-mails created using the “E-mail Window” (FIG. 21A-C).
      E-mail Status
         Displays how the e-mail was directed after its creation.
         Values:
         Sent—E-mail was sent to Php E-mail handler via the internet.
         Held—User held all e-mails.
         Outbox—No Internet available, e-mail was sent to 318.
      Internet Status
         Displays the internet availability during the E-mail's creation.
         Values:
         Connected—Internet Available
         Disconnected—Internet Not Available
      Created
         Displays the date and time E-mail was created.
         Date and time are defined from operating system values.
      Message Recipient
         Displays the Name and E-mail Address of the visitor receiving the message.
Pending E-Mails Data Grid (362):
   Displays e-mails to be created at the termination of the “Open House Session.”
   Columns Include:
      Mail Type
         Displays the type of e-mail to be created at the conclusion of an “Open House Session.”
      E-mail Status
         Displays “Pending.”
      Message Options
         Displays the selected optional message information to be included when email is created.
Save Button (364):
   When selected:
      An Operating System Save window is opened, allowing the “Host User” to choose a file name and hard drive location for the collected E-mail Log data in 360.
Close Button (366):
   When selected:
      The “E-mail Log” window is removed from view.

E-Mail Outbox View/Edit:

(Now referring to FIG. 16)
Contained Elements: 370-380

This program window is used by the “Host User” to view and edit selected E-mails in (outbox).

Elements:
E-Mail Address Text Input (370):
   Displays the selected E-mail's address for review and edit by the “Host User.”
   This element is tab enabled.
E-Mail Subject Text Input (372):
   Displays the selected E-mail's Subject.
   This element is tab enabled.
E-Mail Message Text Input (374):
   Displays the selected E-mail's Message.
   This element is tab enabled.
Message Import Button (376):
   When selected:
      An operating system Browse window is opened, allowing the “Host User” to choose a text file for import into 374.
   This element is tab enabled.
Save Button (378):
   When selected:
      The displayed E-mail is saved to its retrieved location in 318.
   This element is tab enabled.
Close Button (380):
   When selected:
      The “E-mail Outbox View/Edit” window is removed from view.
   This element is tab enabled.

Display Manager Tab:

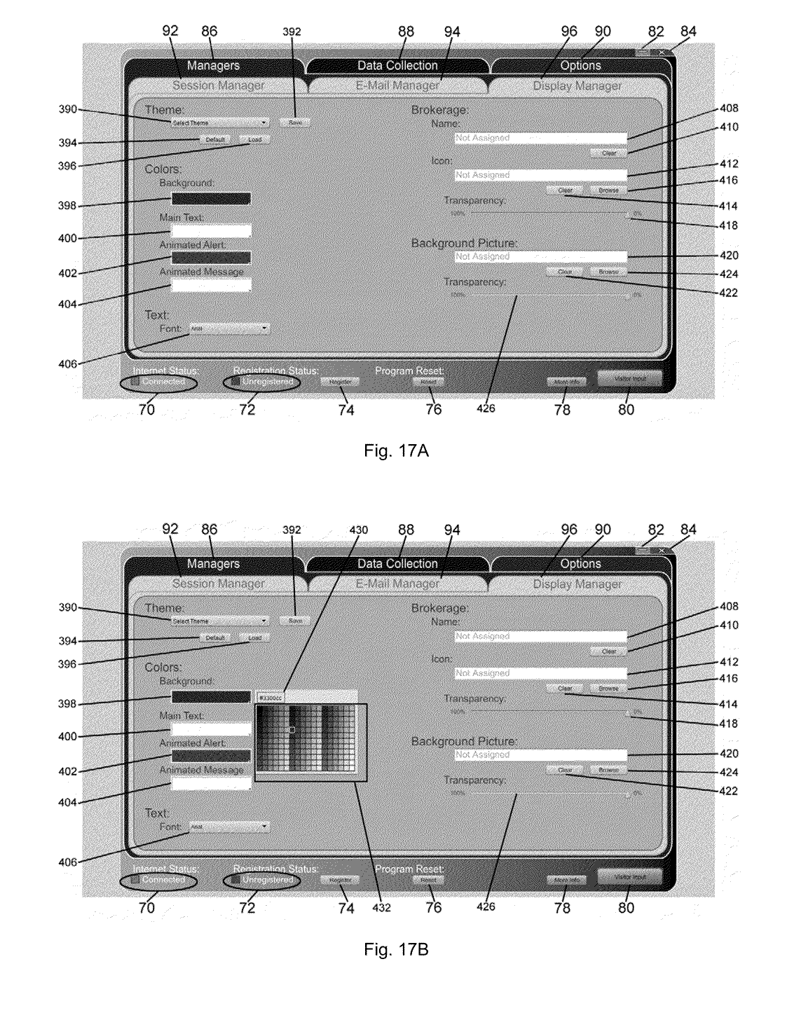

(Now referring to FIG. 17A-B)
Contained Elements: 94, 390-326, 430, 432

This section allows the “Host User” control over the registry's, or “Visitor Input Section's”, look and feel.

Display Manager's sub-titles include:
Theme:
   Controls theme definition.
      This section
Colors:
   Defines the colors to be used while in the “Visitor Input Section.”
Text:
   This section defines the font to be used for all static text in the “Visitor Input Section.”
Brokerage:
   This section defines the “Host Agent's” brokerage information display to visitors during an Open House.
Background Picture:
   This section defines the background image display to visitors during an Open House.
Secondary Controls accessible within this Tab include:
   Color Picker Window: (FIG. 17B)

Display Manager Sub-Titles and Elements

Sub-Title Elements:
ITheme:
   Theme Combo Box (390):
      The “Host User” defines the desired theme to be manipulated.
      These elements are tab enabled.
   Save Button (392):
      When selected:
         The defined display options in elements 398-426 are saved under the selected theme in 390.
      These elements are tab enabled.
   Default Button (394):
      When selected:
         The default values for elements 398-426 are loaded from the selected theme in 390.
      These elements are tab enabled.
   Load Button (396):
      The saved values defined by the “Host User” for elements 398-426 are loaded from the selected theme in 390.
      These elements are tab enabled.
Colors:
   Background Color Picker (398):
      The “Host User” defines the background color to be displayed during the Visitor Input Section.
      When selected:
         The “Color Picker Window” is added to the stage allowing the user to define a color.
   Main Text Color Picker (400):
      The “Host User” defines the static text color to be displayed during the Visitor Input Section.
      When selected:
         The “Color Picker Window” is added to the stage allowing the user to define a color.
   Animate Alert Color Picker (402):
      The “Host User” defines the Alert message color for all animated messages.
      When selected:
         The “Color Picker Window” is added to the stage allowing the user to define a color.
   Animated Message Color Picker (404):
      The “Host User” defines the standard message color for all animated messages.
      When selected:
         The “Color Picker Window” is added to the stage allowing the user to define a color.
Text:
   Font Combo Box (406):
      When changed:
         The selected font is applied to all static text within the Visitor Input Section.
Brokerage:
   Brokerage Name Text Input (408):
      The “Host User” defines the name of their Brokerage of operation.
      When changed:
         The brokerage name is saved and applied to 612.
   Brokerage Name Clear Button (410):
      When selected:
         The saved brokerage name in 408 is erased.
         408 displays “Not Assigned.”
   Icon File Location Text Field (412):
      This text field displays the assigned icon image file's hard drive location.
      If no file is defined, 412 displays “Not Assigned.”
      This element is not selectable or tab enabled.
   Icon Clear Button (414):
      When selected:
         412 is set to “Not Assigned.”
   Icon Browse Button (416):
      When selected:
         The “Operating System File Selection” window is opened allowing the “Host User” to select one image file from a local hard drive location.
         Once image file has been selected:
         The file is loaded into the program.
         Loader errors are displayed in an “Action Status” window (FIG. 6).
         The successfully loaded image file hard drive location is displayed in 412.
   Icon Transparency Slide Bar (418):
      This slide bar sets the alpha value for 620.
      When changed:
         The slide bar value is updated.
         New alpha value for 620 is applied.
Background Picture:
   Background Image File Location Text Field (420):
      This text field displays the assigned image file's hard drive to be used as the Visitor Input Section background image.
      This element is not selectable or tab enabled.
   Image Clear Button (422):
      When selected:
         420 is set to “Not Assigned.”
   Image Browse Button (424):
      When selected:
         The “Operating System File Selection” window is opened allowing the “Host User” to select one image file from a local hard drive location.
         Once image file has been selected:
         The file is loaded into the program.
         Loader errors are displayed in an “Action Status” window (FIG. 6).
         The successfully loaded image file hard drive location is displayed in 420.
   Browse Image Transparency Slide Bar (426):
      This slide bar sets the alpha value for the defined background image.
      When changed:
         The slide bar's value is updated and applied.

Color Picker Window:

(Now referring to FIG. 17B)
Contained Elements: 430, 432

This window is opened when a color picker is selected. The selected color is then applied to its color picker.

Elements:
Hex Color Input (430):
   The user can input the hexadecimal color number in order to define a desired color.
   This element is tab enabled.
Swatch Color Selector (432):
   The user selects the color to be applied from the color swatch.
   This element is tab enabled.

Data Collection Manager Tab:

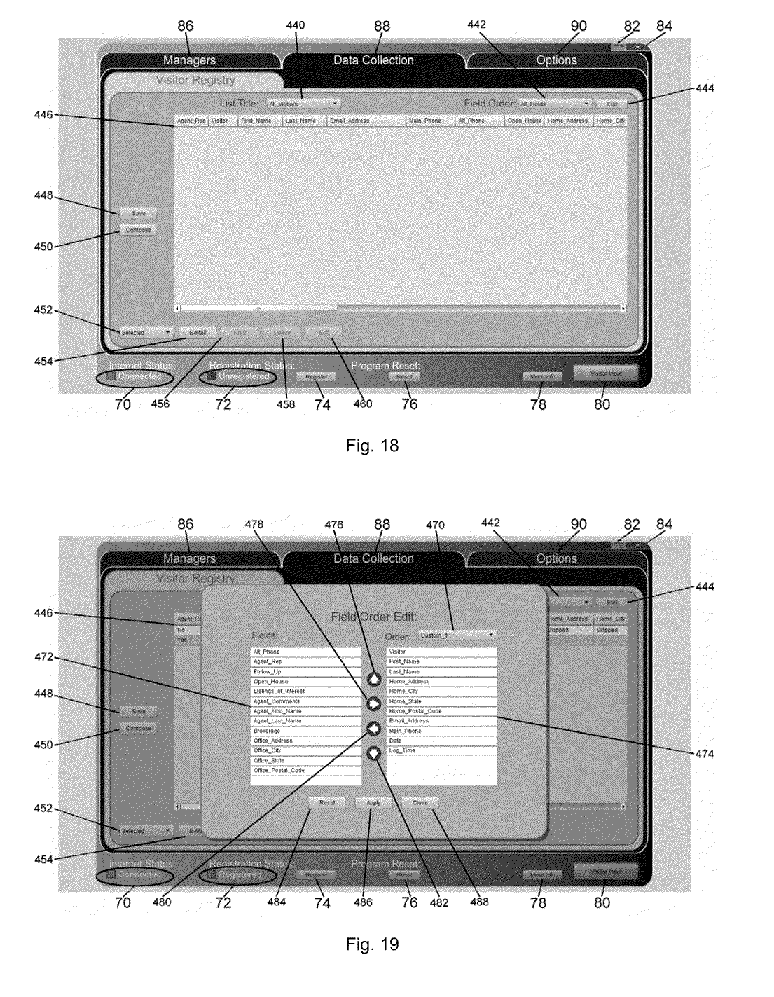

(Now referring to FIG. 18)

Contained Elements: 88, 440-460

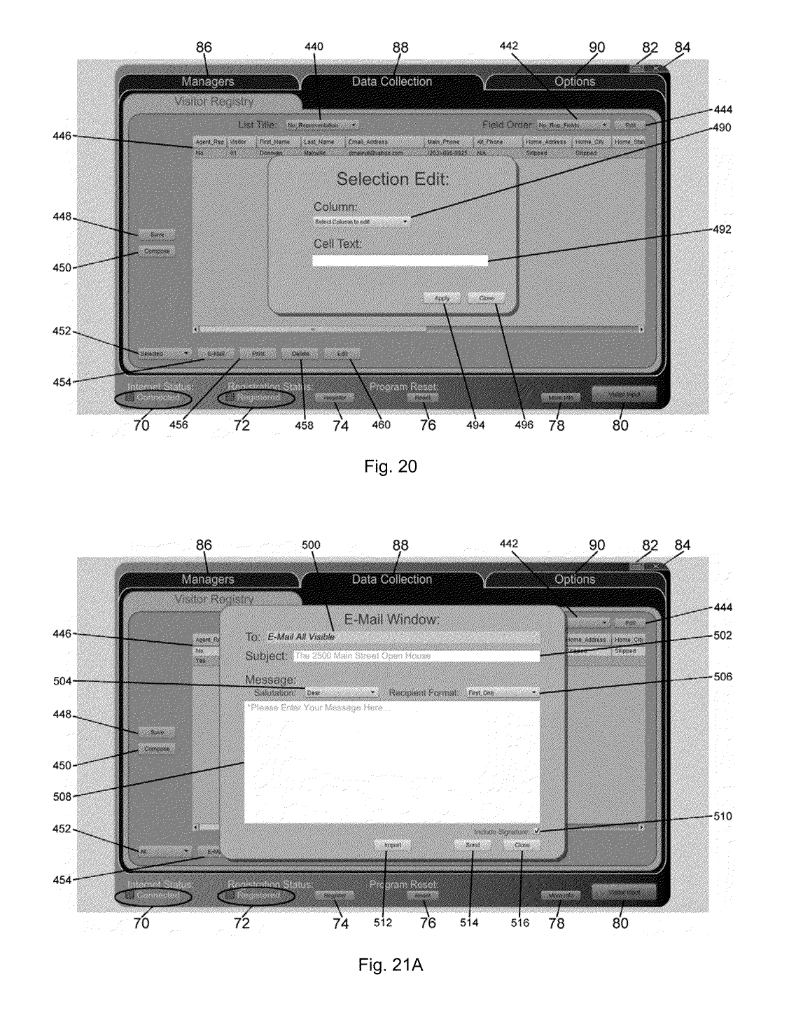

This manager contains the “Visitor Data Profile” collected during an “Open House Session.” The “Host User” can edit and save this data for use in other computer programs. The data can also be used to compose emails.
Secondary Controls accessible within this Tab include:
   Field Order Edit: (FIG. 19)
   Visitor Data Selection Edit: (FIG. 20)
   E-Mail Composition Window: (FIG. 21A-c)

Data Collection Sub-Titles and Elements

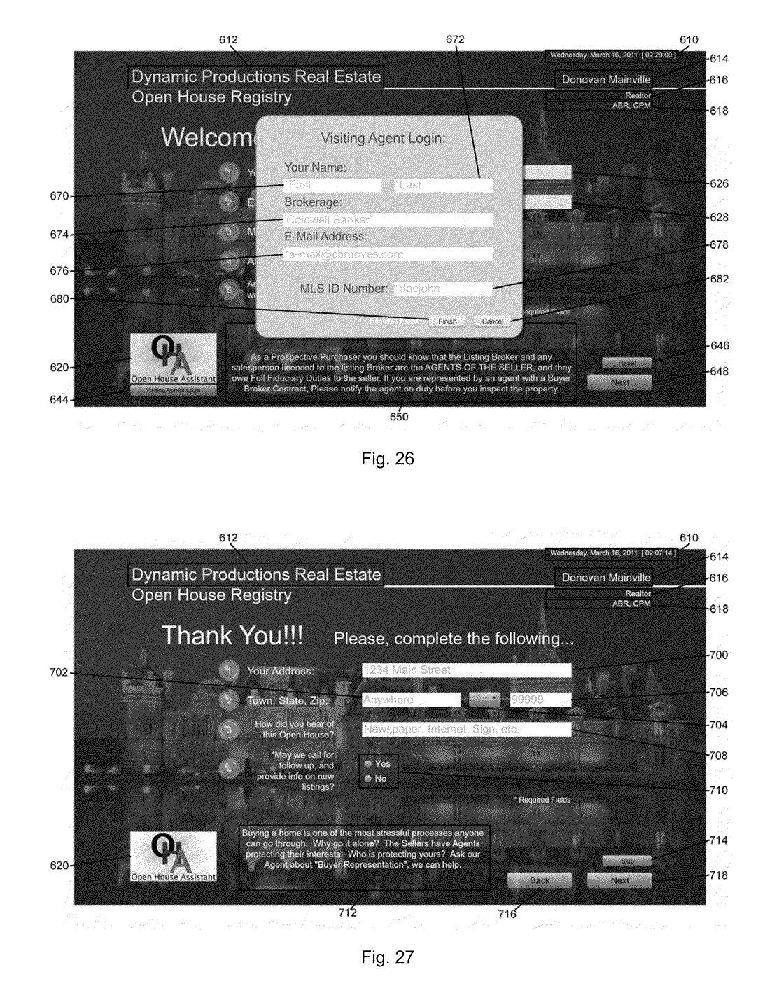

Sub-Title Elements:
Visitor Registry:
   List Title Combo Box (440):
      “Host User” selects the type of “Visitor Data Profiles” to be displayed in 446.
      Options include:
         All
         Represented
         No Representation
         Visiting Agents
      These elements are tab enabled.
   Field Order Combo Box (442):
      “Host User” selects the “Field Order List” to be applied to 446. 442 defines Field Order Columns.
      When changed:
         Visible columns are updated in 446, reflecting the selected list.
   Field Order Edit Button (444):
      When selected:
         The “Field Order Edit” window is added to the stage. (FIG. 19)
      These elements are tab enabled.
   Visitors Data Grid (446):
      Displays the “Visitor Data Profiles” collected during the “Open House Session.”
      Field Columns Include:
         Visitor—displays the visitors order at arrival numerically.
         First Name—displays the visitor's first name.
         Last Name—displays the visitor's last name.
         Home Address—displays the visitor's home address.
         Home City—displays the visitor's home city.
         Home State—displays the visitor's home state.
         Home Postal Code—displays the visitor's home zip code.
         E-Mail Address—displays the visitor's e-mail address.
         Main Phone—displays the visitor's main phone number.
         Alt. Phone—displays the visitor's alternate phone number.
         Date—displays the date the visitor registered.
         Log Time—displays the time the visitor registered.
         Agent Rep.—displays the visitor's agent representation.
         Follow Up—displays the visitor's answer to follow up by the “Host Agent”.
         Open House—displays how the “Visitor” heard of the open house.
         Agent Comment—displays Agent's notes for each visitor.
         Listings of Interests—displays the visitor's property criteria.
         Agent First Name—displays the first name of the visitor's agent.
         Agent Last Name—displays the last name of the visitor's agent.
         Brokerage—displays the Brokerage Name of the visitor's Agent or the “Visiting Agent's” Brokerage Name.
         Office Address—displays the street address of the visitor's agent office.
         Office City—displays the city of the visitor's agent office.
         Office State—displays the state of the visitor's agent office.
         Office Zip Code—displays the zip code of the visitor's agent office.
      These elements are tab enabled.
   Visitors Save Button (448):
      When selected:
         The visible “Visitor Data Profiles” in 446 are formatted into a comma delineated string using the defined field order in 442.
      An Operating System Save window opens, allowing the user to define the file name and hard drive save location for the formatted string.
      These elements are tab enabled.
   Compose Button (450):
      When selected:
         The “E-Mail Window” is added to the stage. (FIG. 21C)
      These elements are tab enabled.
   Select/All Combo Box (452):
      Defines whether one selected “Visitor Data Profile” or All “Visitor Data Profiles” from 446 are utilized when elements 454, 456, 458, or 460 are selected.
      These elements are tab enabled.
   E-Mail Button (454):
      If 452 displays “Selected” when clicked:
         The “E-Mail Window” is added to the stage. (FIG. 21B)
      If 452 displays “All” when clicked:
         The “E-Mail Window” is added to the stage. (FIG. 21A)
      These elements are tab enabled.
   Print Button (456):
      If 452 displays “Selected”, and a “Visitor Data Profile” is selected in 446 when clicked:
         The selected “Visitor Data Profile” in 446 is formatted into a string for printing.
         An Operating System Print Window allows the “Host User” to set print parameters and print the formatted string.
      These elements are tab enabled.
   Delete Button (458):
      If 452 displays “Selected” when clicked:
         The selected “Visitor Data Profile” in 446 is removed.
      If 452 displays “All” when selected:
         All collected “Visitor Data Profiles” are deleted.
      These elements are tab enabled.
   Edit Button (460):
      If 452 displays “Selected” and a “Visitor Data Profile” selected in 446 when clicked:
         The “Visitor Data Selection Edit” window is added to the stage. (FIG. 26)
      These elements are tab enabled.

Data Collection Secondary Controls

Field Order Edit:

(Now referring to FIG. 19)
Contained Elements: 470-488

This window allows the “Host User” to edit and save a custom field order to a list to save.

Elements:
Field Order Combo Box (470):
   Displays the custom field order list being edited.
   “Host User” may select from three list titles
      Custom 1
      Custom 2
      Custom3
   This element is tab enabled.
Fields List (472):
   Displays Field Titles NOT to be used in the defined “Custom Field Order.”
   This element is tab enabled.
Order List (474):
   Displays Field Titles to be used in the defined “Custom Field Order.”
   Order is defined from Titles top to bottom.
   This element is tab enabled.
Field Up Button (476):
   Moves the selected Field in 474 up one position in 474's order.
   This element is tab enabled.
Fields To Order Button (478):
   Moves the selected Title in 472 to the bottom of the defined Field order in 474.
   This element is tab enabled.
Order To Fields Button (480):
   Moves the selected Title in 474 to the bottom unused Field Titles in 472.
   This element is tab enabled.
Field Down Button (482):
   Moves the selected Field in 474 down one position in 474's order This element is tab enabled.
Reset Button (484):
   When selected:
      The saved “Custom Field Order” defined in 470 is erased.
      All Field Titles are moved into 472 in the default order.
   This element is tab enabled.
Apply Button (486):
   When selected:
      The defined “Field Order” in 474 is applied to the selected “Field Order” in 470 and saved to shared objects for later retrieval.
Close Button (488):
   When selected:
      The “Field Order Edit” window is removed from the stage and view.
   This element is tab enabled.

Visitor Data Selection Edit:

(Now referring to FIG. 20)
Contained Elements: 490-496

The Client Profile Selection Edit Control” provides the “Host User” with the ability to edit a stored “Client Profile” from the “Client Database”.

The “Client Database Column Headers” are loaded into the “Column” Combo Box.

Elements:
Column Combo Box (Visitor Data Edit) (490):
   When changed:
      The corresponding value contained within the selected “Client Profile” in 210 is displayed in 252.
   This element is tab enabled.
Cell Text—Text Input (Visitor Data Edit) (492):
   Initially displays the current value for the selected title of element 250.
   “Host User” inputs a new value for the displayed 250 selection.
   This element is editable and tab enabled.
   This element is tab enabled.
Apply Button (Visitor Data Edit) (494):
   When selected:
      252 is updated. The current profile value for the selected column in 250 is updated to the selected profile in 210 with the value in 252.
      The Client Profile is updated within 210 and stored internally.
   This element is tab enabled.
Close Button (Visitor Data Edit) (496):
   When selected:
      The “Client Profile Selection Edit Control” window and elements are removed from the stage.
      Focus is set to 220.
   This element is tab enabled.

Email Window:

(Now referring to FIG. 21A-C)
Contained Elements: 500-516

There are three ways to create emails manually from Data Collection and to access the “E-mail Window.” When 452 equals “All” and 454 is selected, the “E-mail Window” is opened in the “E-mail All” state. (FIG. 12A)

When a “Visitor Data Profile” is selected in 446, 452 equals “Selected,” and 454 is selected, the “E-mail Window” is opened in the “E-mail Selected” state. (FIG. 12B)

When 450 is selected, the “E-mail Window” is opened in “E-mail Compose” state. (FIG. 12C)

Elements:
E-mail To: Text Input (500):
   When State equals:
      “E-mail All”
         500 displays “E-mail All Visible.”
         500 is disabled and not available for edit.
      “E-mail Selected”
         500 displays the visitor's E-mail address and Full Name from the selected “Visitor Data Profile” in 446.
         500 is disabled and not available for edit.
      “E-mail Compose”
         “Host User” inputs recipient's e-mail address.
         500 displays “*Jonny Noname <JonnyNoname@anonymous.com>”
         500 is available for edit and it is tab enabled.
E-mail Subject Text Input (502):
   When state equals:
      “E-mail All” or “E-mail Selected”
         502 displays “The”, plus 112, plus “Open House.”
      “E-mail Compose”
         “Host User” inputs e-mail subject.
         502 displays “*Please Enter Your Message Subject”
         This Element is available for edit and it is tab enabled.
E-mail Salutation Combo Box (504):
   Only available in “E-mail Compose” State.
   When changed:
      The selected greeting in 504 is added to the beginning of the outgoing message.
         Options: Dear, Hello, and None.
   This element is tab enabled.
E-mail Recipient Format Combo Box (506):
   Only available in “E-mail Compose” State.
   When changed:
      The selected format in 506 is added to the outgoing message following the selected salutation in 504.
         Options:
         First Only=Visitor's First Name Only
         First and Last=Visitor's Full Name
         Visitor=Visitor This element is tab enabled.
E-mail Message Text Input (508):
   “Host User” inputs desired e-mail message.
   This element is tab enabled.
Include Signature Check Box (510):
   When checked:
      310 is added to the end of the outgoing message.
   This element is tab enabled.
Message Import Button (512):
   When selected:
      An Operating System Browse window is opened allowing the “Host User” to choose a text file for import into 508.
   This element is tab enabled.
E-mail Send Button (514):
   When State equals:
      “E-mail All”
         Using a looping statement, an e-mail is created for all visitors listed in 446.
      “E-mail Selected” or “E-mail Composed”
         An e-mail is created addressed to the entry in 508.
   If Internet connection is available:
      Messages are sent to the Php E-mail Handler.
   If Internet connection is not available:
      Messages are sent to 318.
E-mail Window Close Button (516):
   When selected:
      The “E-mail Window” is removed from view.
   This element is tab enabled.

Options Tab

(Now referring to FIG. 28)

Contained Element: 90

Options Tab contains two sub-tabs:
Output Tab (520)
   This tab contains controls used for information output to social networks or database upload.
Form Manager Tab Title (522)
   This tab contains controls used to edit and save both “E-mail Forms” and “Animated Message Forms.”

Options Tab Elements

Miscellaneous Elements:
Options Tab Title (90):
   When selected:
      The Options Tab and Sub-Tabs are brought to the foreground.
   This element is tab enabled.

Output Tab:

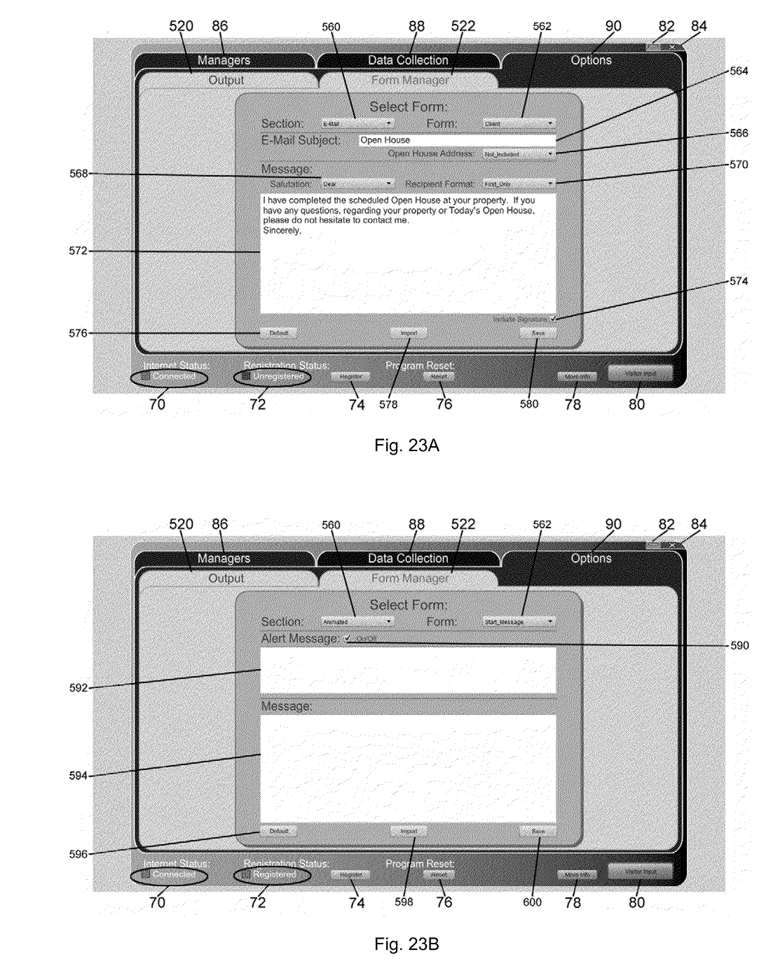

(Now referring to FIG. 22A-B)

Contained Elements: 520, 524-552

The Output's sub-titles include:
Social Network Login:
   Contained controls are used to Login to multiple Social Networks.
Social Network Message Post:
   Contains controls for composing and posting messages to the linked Social Network.
File Export:
   Contains controls for exporting collected “Visitor Data” as different file formats.

Output Tab Elements

Sub-Title Elements:
Social Network Login:
   Social Network Combo Box (524):
      Contains the list of available social networks
         Facebook
         Twitter
         Myspace
         Linkedin
         Hi5
         Tumblr
      When changed:
         The selected Social Network is accessed during Login.
      This element is tab enabled.
   Social Network Status Text Field (526):
      Displays connection status to the selected network in 524.
      This element is tab enabled.
   Social Network Username Input (528):
      “Host User” inputs their username for the social network displayed in 524.
      This element is tab enabled.
   Social Network Password Input (530):
      “Host User” inputs their password for the social network username displayed in 528.
      This element is tab enabled.
   Remember Login Check Box (532):
      When checked:
         a 528 and 530 are stored for the selected social network in 524.
      This element is tab enabled.
   Network Login Button (534) (FIG. 22A):
      The username (528) and password (530) are sent via the internet to social network server in 524.
      This element is tab enabled.
   Network Log Out Button (552) (FIG. 22B):
      When selected:
         The user is logged out at the social network server selected in 524.
      This element is tab enabled.
Social Network Message Post:
   Linked Network Text Field (544):
      Displays the social network that is currently connected.
         If no network is connected, the text field displays “Not Linked.”
      This element is not selectable or tab enabled.
   Linked User Text Field (546):
      Displays the Full Name of user connected with the username in 528.
      This element is not selectable or tab enabled.
   Message Post Text Input (548):
      The “Host User” inputs the desired message to be uploaded to the linked network displayed in 544.
      This element is not selectable or tab enabled.
   Message Post Button (550):
      When selected:
         548 is uploaded and posted to the ‘wall’ or bulletin board of the linked Network displayed in 544.
      This element is not selectable or tab enabled.
File Export:
   Data Collections Combo Box (536):
      “Host User” selects which “Visitor Data Profiles” are to be exported.
      Visitor Lists Include:
         All—All Visitors
         No Representation
         Represented
         Visiting Agents
      This element is tab enabled.
   Field Order Combo Box (538):
      “Host User” selects which fields from the “Visitor Data Profiles” to be exported.
      List Includes:
         All—All Fields
         Custom_1—user defined Field Order List
         Custom_2—user defined Field Order List
         Custom_3—user defined Field Order List
      This element is tab enabled.
   File Format Combo Box (540):
      “Host User” selects which file format for the “Visitor Data” is exported.
      Formats Include:
         Excel files
         Word files
         Text files
         CSV files
      This element is tab enabled.
   Export File Button (542):
      The “Visitor Data” information defined by selections in 536, 538, and 540.
      This element is tab enabled.
Miscellaneous Elements:
   Options Tab Title (520):
      When selected:
         The Output Tab is brought to the foreground.

Form Manager Tab:

(Now referring to FIG. 23A-B)

Contained Elements: 522, 560-600

The Form Manager's sections include:
E-Mail:
   The “Host User” edits and saves the E-Mail Form definitions used to create Automated E-Mails.
Animated:
The “Host User” edits and saves Animated Messages displayed to “Visiting Users” throughout the “Visitor Input Section.”
Form Manager Tab Constant Elements
   Section Combo Box (560):
      “Host User” selects Form Section.
      When changed:
         The selected Form Section is displayed.
         E-Mail Section (FIG. 23A)
         Animated Section (23B)
      This element is tab enabled.
   Form Combo Box (562):
      E-Mail Section Forms Include:
         Client—Client Auto E-Mail Form
         No Representation—No Representation Auto E-Mail Form
         Represented—Represented Auto E-Mail Form
         Visiting Agent—Visiting Agent Auto E-Mail Form
      Animated Section Forms Include:
         Start_{—} Message—Animated message displayed in 650.
         No_Rep_1_Message—Animated message displayed in 712.
         No_Rep_2_Message—Animated message displayed in 758.
         Rep'd Message—Animated message displayed in 818.
      This element is tab enabled.
Sections Elements:
E-Mail Form (FIG. 23A):
   E-mail Subject Text Input (564):
      “Host User” inputs the E-Mail subject to be applied to the auto e-mail form selected in 562.
      This element is tab enabled.
   Open House Address Combo Box (566):
      “Host User” selects how to include the “Open House Address” in the “E-Mail Subject” when the form's auto email is created.
      Options Include:
         Open House Prefix—Applies 112 (Open House Address) to proceed and include the subject text (564) for the auto-email selected in 562.
         Open House Address Suffix—Applies 112 to include and follow the subject text (564) for the auto-email selected in 562.
         No Open House Address—Does not add the Open House Address to the selected form's subject text.
      This element is tab enabled.
   Salutations Combo Box (568):
      The “Host User” selects greeting to be added to the auto e-mail message of the form selected in 562.
      Options: Dear, Hello, and None.
      This element is tab enabled.
   Recipient Format Combo Box (570):
      The “Host User” selects a recipient format to be used to add the recipient to the auto e-mail message of the form selected in 562.
      Options:
         First Only=Visitor's First Name Only
         First and Last=Visitor's Full Name
         Visitor=Visitor
      This element is tab enabled.
   E-mail Message Text Input (572):
      “Host User” inputs the E-Mail message to be applied to the auto e-mail form selected in 562.
      This element is tab enabled.
   Include Signature Check Box (574):
      When checked:
         310 is added to the end of form's message on auto-email creation.
      This element is tab enabled.
   E-mail Form Default Button (576):
      When selected:
         Resets the form selected in element 562 to its default settings.
      This element is tab enabled.
   E-mail Form Import Button (578):
      When selected:
         An operating system Browse window is opened, allowing the “Host User” to choose a text file for import into 572.
      This element is tab enabled.
   E-mail Form Save Button (580):
      When selected:
         Values for elements 564-574 are saved for the selected form in 562.
      This element is tab enabled.
Animated Form (FIG. 23B):
   Alert Message On/Off Check Box (590):
      When checked:
         592 and 594 are combined to be displayed in the form's Visitor Input Section display location.
      When unchecked:
         Only 594 is displayed in the form's Visitor Input Section display location.
      This element is tab enabled.
   Alert Message Text Input (592):
      “Host User” inputs alert message text for the form selected in 562.
      This element is tab enabled.
   Message Text Input (594):
      “Host User” inputs message text for the form selected in 562.
      This element is tab enabled.
   Animated Form Default Button (596):
      When selected:
         Resets the form selected in element 562 to its default settings.
      This element is tab enabled.
   Animated Form Import Button (598):
      When selected:
         An operating system Browse window is opened, allowing the “Host User” to choose a text file for import into 594.
      This element is tab enabled.
   Animated Form Save Button (600):
      When selected:
         Resets the form selected in element 562 to its default settings.
      This element is tab enabled.

Miscellaneous Elements:
Form Manager Tab Title (522):
   When selected:
      The Form Manager Tab is brought to the foreground.

Visitor Input Section

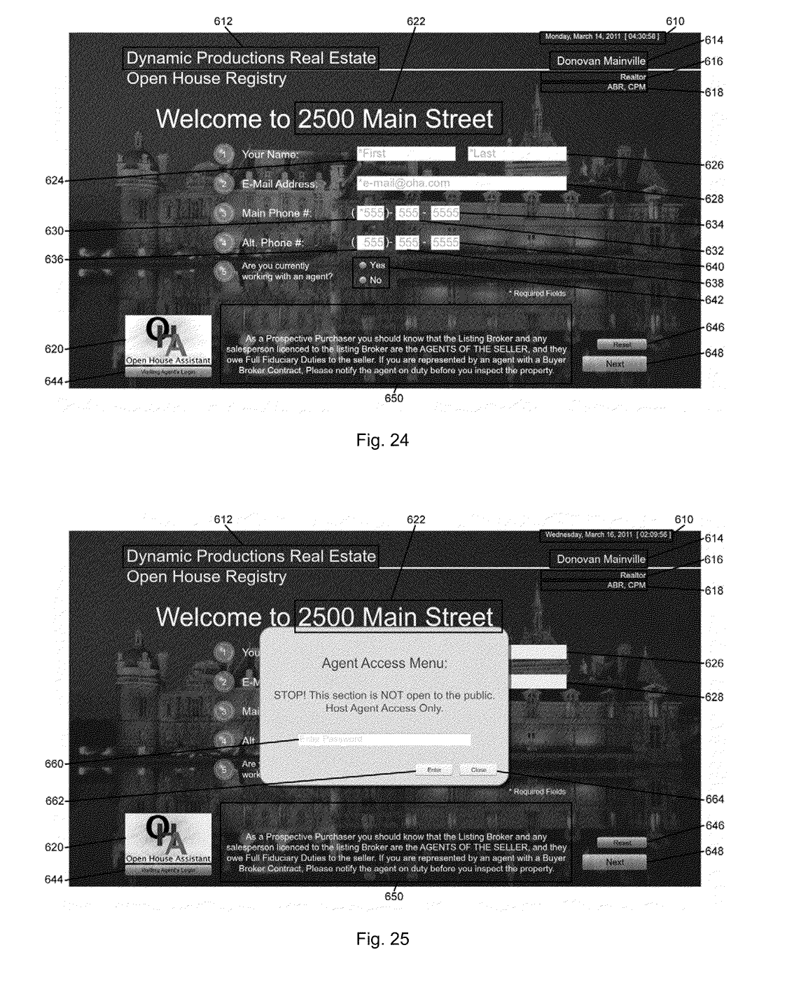

This section provides the “Visitor”, an Individual attending the Open House, access to the registry forms of the OHA Program. As the “Visitor” completes the registry forms, their entries are saved for their review. Once they are accepted, these values are saved as a “Visitor Data Profile” to 446. This section is used and seen by the public attending the Open House. Each “Visitor” begins their registration at the “Visitor Startup Data Form” (FIG. 24).

Visitor Input Section Constant Elements
Calendar and Digital Clock (610):
   This text field is populated with the current date and time
      Date and Time are updated from the operating system's internal clock and calendar.
   These elements are tab enabled.
Brokerage Display text Field (612):
   Displays the Brokerage Name defined in 408
      If 408 equals “Not Assigned”
         612 has no entry.
   These elements are tab enabled.
Host Agent Display Text Field (614):
   Displays the Host Agent name defined in 100.
   These elements are tab enabled.
Description Line 1 Display Text Field (616):
   Displays text entry defined in 102.
   These elements are tab enabled.
Description Line 2 Display Text Field (618):
   Displays text entry defined in 104.
Brokerage Icon (620):
   Element is loaded with the defined Icon Image File defined in 412.
   If no image is defined in 412
      The “Open House Assistant” default icon is loaded. Example (FIG. 24)

Visitor Startup Data Form:

(Now referring to FIG. 24)

Contained Elements: 622-650

This is the start data entry form that “Visiting Users” are asked to complete during their registration process. It is only completed by “Visiting Users”, not “Visiting Agents.” Entries made to this form are saved to the Visitor's “Data Profile” when registration is completed.

Secondary Controls accessible within this Form include:
Agent Access Menu: (FIG. 25)
Visitor Agent Login: (FIG. 26)

Visitor Startup Data Form Elements
Open House Address Display Text Field (622):
   Displays the “Open House Address” defined in 112.
Visitor's First Name Text Input (624):
   “Visitor” inputs their first name.
Visitor's Last Name Text Input (626):
   “Visitor” inputs their last name.
Visitor's E-mail Address Text Input (628):
   “Visitor” inputs their E-Mail Addresses.
Main Phone Text Field 1 (630, 632, 634):
   “Visitor” inputs their Main Phone Number(s) within these three text fields.
Alt. Phone Text Field 1 (636, 638, 640):
   “Visitor” inputs their Alt. Phone Number(s) within these three text fields.
Question 5 Radio Button Group (642):
   “Visitor” indicates their “Agent Representation” status
      “Yes” Radio Button—indicates visitor is currently represented by an agent.
      “No” Radio Button—indicates visitor is not currently represented by an agent.
Visiting Agent Login Button (644):
   When selected:
      The “Visiting Agent Login” window is added to the stage and view.
Reset Button (Visitor Startup Data Form) (646):
   When selected:
      Fields 624-640 are reset to default start text values. Example (FIG. 24).
      642 Radio Buttons are deselected. Example (FIG. 24).
Next Button (Visitor Startup Data Form) (648):
   If fields 624-634 contain valid entries, and 642 equals “No” when selected:
      The program navigates to “No Rep Data Form” (FIG. 27).
      Values for 624-642 are saved
         If no value has been entered into an element, it is set to “N/A” and saved.
   If fields 624-634 contain valid entries, and 642 equals “Yes” when selected:
      The program navigates to “Rep'd Data Form” (FIG. 30).
      Values for 624-642 are saved.
         If no value has been entered into an element, it is set to “N/A” and saved.
   If any required fields contain invalid entries, when selected:
      The “Action Status” window and elements (FIG. 6) are added to the stage, displaying the deficiencies that need to be met in order to save values for 624-642 and navigate to either:
         Rep'd Data Form (FIG. 30)
         No Rep Data Form 1 (FIG. 27)
Animated Start Message Display Text Field (650):
   Displays the “Host User” defined Animated “Start Message” form.

Visitor Startup Data Form Secondary Controls

Agent Access Menu:

(Now referring to FIG. 25)

Contained Elements: 660-664

This window allows the “Host User” to re-enter the Host User Section. The password protection prevents “Visiting Users” from entering the “Host User Section” accidently.

Elements:
Password Text Input (660):
   “Host User” enters their “Open House Section Password” (124).
Enter Button (Agent Access) (662):
   If 660 matches 124 when selected
      The program navigates to the Host User Section (FIG. 1)
Close Button (Agent Access) (664):
   When selected:
      The “Agent Access Menu” is removed from the stage and view.

Visitor Agent Login:

(Now referring to FIG. 26)

Contained Elements: 670-682

“Visiting Agents” use this window to register at the Open House.

Elements:
Visiting Agent First Name Text Input (670):
   “Visiting Agent” enters their First Name.
Visiting Agent Last Name Text Input (672):
   “Visiting Agent” enters their Last Name.
Visiting Agent Brokerage Text Input (674):
   “Visiting Agent” enters their Brokerage Name.
Visiting Agent E-mail Address Text Input (676):
   “Visiting Agent” enters their E-Mail Address.
Visiting Agent MLS ID Number Text Input (678):
   “Visiting Agent” enters their MLD ID Number.
Visiting Agent Login Finish Button (680):
   If fields 670-678 contain valid entries, when selected:
      The collected values 670-678 are applied to their assigned fields within the “Visitor Data Profile” added to 446.
      The “Visiting Agent Login” window is removed from the stage and view.
   If any required fields contain invalid entries, when selected:
      The “Action Status” window and elements (FIG. 6) are added to the stage, displaying the deficiencies that need to be met in order to save the “Visiting Agent's Data Profile” to 446.
Visiting Agent Login Close Button (682):
   When selected:
      The “Visiting Agent Login” window is removed from the stage and view.

No Rep Data Form 1:

(Now referring to FIG. 27)

Contained Elements: 700-718

This is the second data entry form for “Visiting Users” with no agent representation.
No Rep Data Form 1 Elements
Visitor's Street Address Text Input (700):
   “Visitor” inputs their street address.
Visitor's Town Text Input (702):
   “Visitor” inputs their town.
Visitor's State Text Input (704):
   “Visitor” inputs their state.
Visitor's Zip Code Text Input (706):
   “Visitor” inputs their zip code.
Open House Discovery Text Input (Not Rep Data Form 1) (708):
   “Visitor” inputs how they heard of the open house.
Question 4 Radio Button Group (No Rep Data Form 1) (710):
   “Visitor” selects Yes or No to the follow-up by “Host Agent”.
Animated No Rep Message 1 Display Text Field (712):
   Displays the “Host User” defined Animated “No Rep 1 Message” Form.
Skip Button (No Rep Data Form 1) (714):
   When selected:
      The program navigates to “No Rep Data Form 2” (FIG. 28).
      700-710 values are set to “skipped” and saved.
Back Button (No Rep Data Form 1) (716):
   When selected:
      The program navigates to “Visitor Startup Data Form” (FIG. 24).
      700-710 are reset to invalid value.
Next Button (No Rep Data Form 1) (718):
   When selected”
      The program navigates to “No Rep Data Form 2” (FIG. 28).
      Values for 700-710 are saved.
         If no value has been entered into the element, it is set to “N/A” and saved.

No Rep Data Form 2:

(Now referring to FIG. 28)

Contained Elements: 720-764

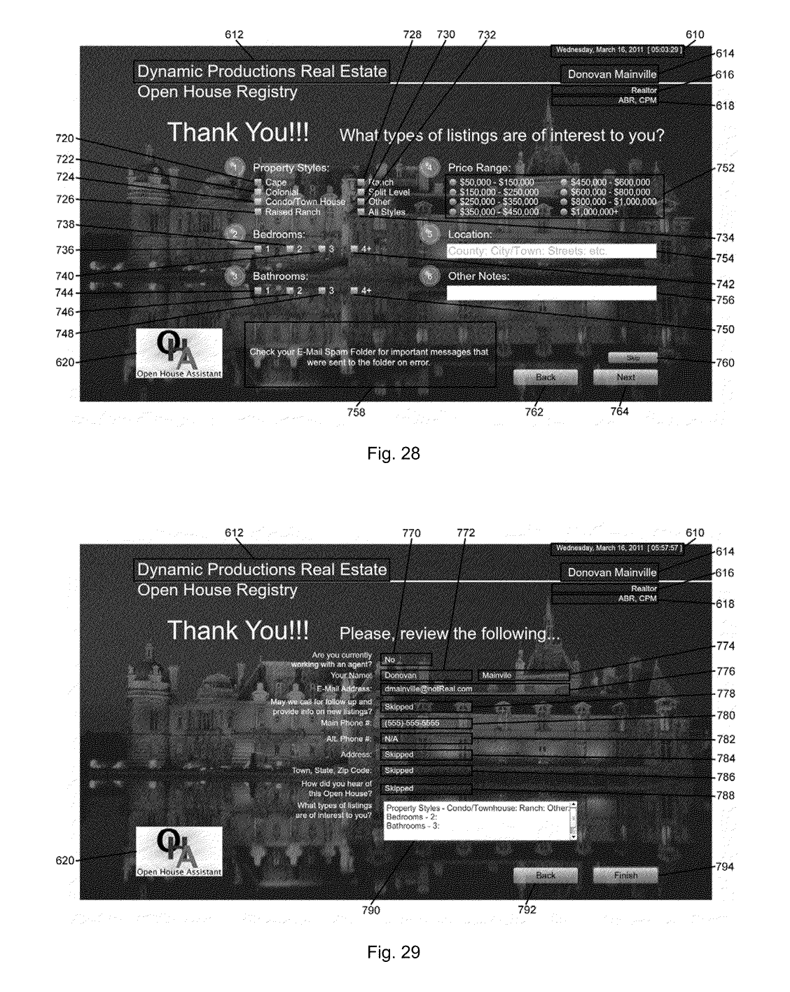

This is the third data entry form for “Visiting Users” with no agent representation.
No Rep Data Form 2 Elements
Cape Check Box (720):
   When checked:
      The element value is added to the “Property Styles” string and displayed in 790.
Colonial Check Box (722):
   When checked:
      The element value is added to the “Property Styles” string and displayed in 790.
Condo/Town House Check Box (724):
   When checked:
      The element value is added to the “Property Styles” string and displayed in 790.
Raised Ranch Check Box (726):
   When checked:
      The element value is added to the “Property Styles” string and displayed in 790.
Ranch Check Box (728):
   When checked:
      The element value is added to the “Property Styles” string and displayed in 790.
Split Level Check Box (730):
When checked:
   The element value is added to the “Property Styles” string and displayed in 790.
Other Check Box (732):
   When checked:
      The element value is added to the “Property Styles” string and displayed in 790.
All Styles Check Box (734):
   When checked:
      The element value is added to the “Property Styles” string and displayed in 790.
1 Check Box (Bedroom) (736):
   When checked:
      The element value is added to the “Bedroom” string and displayed in 790.
2 Check Box (Bedroom) (738):
   When checked:
      The element value is added to the “Bedroom” string and displayed in 790.
3 Check Box (Bedroom) (740):
   When checked:
      The element value is added to the “Bedroom” string and displayed in 790.
4 Check Box (Bedroom) (742):
   When checked:
      The element value is added to the “Bedroom” string and displayed in 790.
1 Check Box (Bathroom) (744):
   When checked:
      The element value is added to the “Bathroom” string and displayed in 790.
2 Check Box (Bathroom) (746):
   When checked:
      The element value is added to the “Bathroom” string and displayed in 790.
3 Check Box (Bathroom) (748):
   When checked:
      The element value is added to the “Bathroom” string and displayed in 790.
4 Check Box (Bathroom) (750):
   When checked:
      The element value is added to the “Bathroom” string and displayed in 790.
Price Range Radio Button Group (752):
   “Visitor” selects desired price range.
   When selected:
      The selected radio buttons value is added to the “Price Range” string and displayed in 790.
Location Text Input (754):
   “Visitor” enters property locations they wish to search.
      Visitor's entry is added to the “Location” string and displayed in 790.
Other Notes Text Input (756):
   The “Visitor” enters additional property criteria not previously covered.
   This visitors' Entry is added to “Other Notes” string and displayed in 790.
Animated No Rep Message 2 Display Text Field (758):
   Displays the “Host User” defined Animated “No Rep 2 Message” Form.
Skip Button (No Rep Data Form 2) (760):
   When selected:
      The program navigates to “No Rep Data Review” (FIG. 29)
      790 is set to skipped.
Back Button (No Rep Data Form 2) (762):
   When selected:
      The program navigates to “No Rep Data Form 1” (FIG. 27)
      720-756 are reset to initial values.
Next Button (No Rep Data Form 2) (764):
   When selected:
      The program navigates to “No Rep Data Review” (FIG. 29)
      The collected strings from elements 720-756 are combined, saved, and displayed in 790.
   If no values are found in elements 720-756:
      790 is set to “N/A” and saved.

No Rep Data Review:

(Now referring to FIG. 29)

Contained Elements: 770-794

The “Visitor” reviews their previously enteed values during the registration process.
No Rep Data Review Elements
Question 5 Review Text Field (Visitor Startup Data Form) (770):
   Displays visitor's selection from 642.
Visitor's First Name Review Text Field (772):
   Displays visitor's entry from 624.
Visitor's Last Name Review Text Field (774):
   Displays visitor's entry from 626.
Visitor's E-Mail Address Review Text Field (776):
   Displays visitor's entry from 628.
Question 4 Review Text Field (No Rep Data Form 1) (778):
   Displays visitor's selection from 710.
Visitor's Main Phone Review Text Field (780):
   Displays the visitor's main phone number entered in fields (630, 632, and 634).
Visitor's Alt. Phone Review Text Field (782):
   Displays the visitor's alternate phone number entered in fields (636, 638, and 640).
      No save entry displays “N/A”
Visitor's Street Address Review Text Field (784):
   Displays the visitor's entry from 700.
      No saved entry displays “N/A”
Visitor's Town, State, and Zip Code Review Text Field (786):
   Displays the visitor's entries from 702, 704, and 706.
      No saved entries displays “N/A”
Open House Discovery Review Text Field (788):
   Displays the visitor's entry from 708.
      No saved entry displays “N/A”
Visitor's Property Criteria Review Text Area (790):
   Displays “Visitor” string data collected from elements 720-756.
Back Button (No Rep Data Review) (792):
   When selected:
      The program navigates back to “No Rep Data Form 2” (FIG. 28).
Finish Button (No Rep Data Review) (794):
   When selected:
      The saved visitor entries displayed elements 770-790 are applied to their assigned fields within a “Visitor Data Profile” and added to 446.

Rep'd Data Form:

(Now referring to FIG. 30)

Contained Elements: 800-822

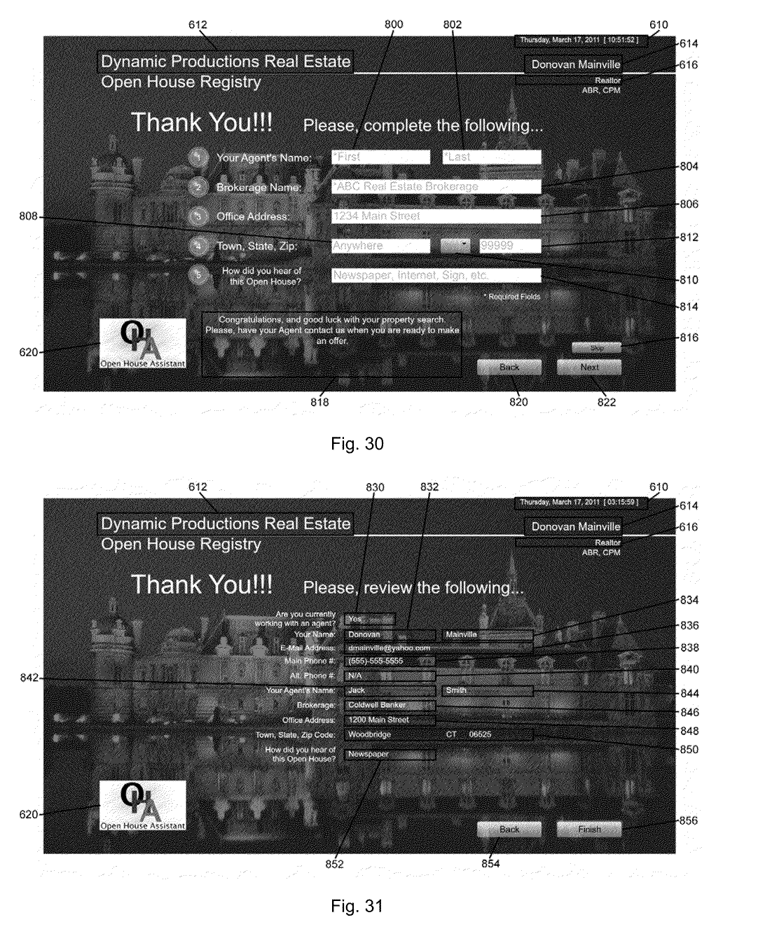

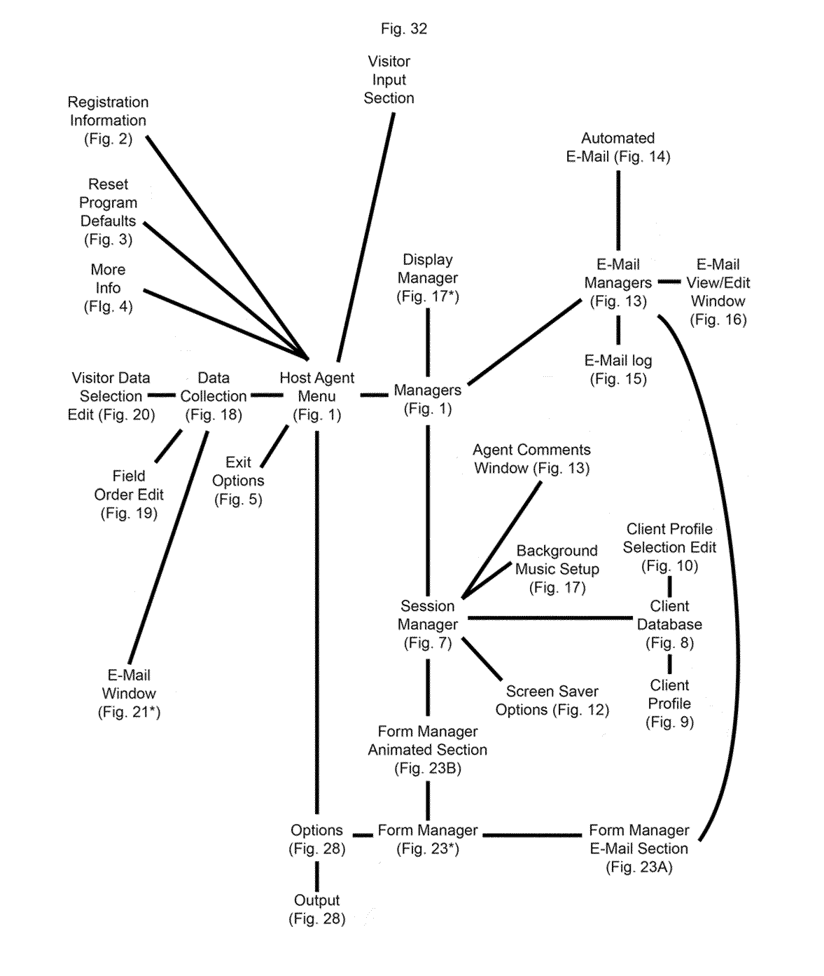

The “Visitor” reviews the previous entered values during the registration process.
Rep'd Data Form Elements
Visitor Agent's First Name Text Input (800):
   Visitor inputs their agent's first name.
Visitor Agent's Last Name Text Input (802):
   Visitor inputs their agent's last name.
Visitor Agent's Brokerage Text Input (804):
   Visitor inputs their agent's brokerage name.
Visitor Agent's Office Address Text Input (806):
   Visitor inputs their agent's office street address.
Visitor Agent's Office Town Text Input (808):
   Visitor inputs their agent's office town.
Visitor Agent's Office State Text Input (810):
   Visitor inputs their agent's office state.
Visitor Agent's Office Zip Code Text Input (812):
   Visitor inputs their agent's office zip code.
Open House Discovery Text Input (Rep'd Data Form) (814):
   Visitor inputs how they heard of the open house.
Skip Button (Rep'd Data Form) (816):
   When selected:
      The program navigates to “Rep'd Data Review” (FIG. 31).
      800-814 are set to “skipped” and saved.
Animated Rep'd Message Display Text Field (818):
   Displays the defined Animated “Rep'd Message Form”.
Back Button (Rep'd Data Form) (820):
   When selected:
      The program navigates to “Visitor Startup Data Form” (FIG. 24).
      800-814 are reset to invalid values.
Next Button (Rep'd Data Form) (822):
   When selected:
      The program navigates to “Rep'd Data Review” (FIG. 31).
      The values from elements 800-814 are saved.
      If no values are found in elements 800-814:
         The missing entries are set to “N/A” and saved.

Rep'd Data Review:

(Now referring to FIG. 31)

Contained Elements: 830-856

The “Visitor” reviews their previously entered values during the registration process.
No Rep Data Review Elements
Question 5 Review Text Field (Visitor Startup Data Form) (830):
   Displays visitor's saved selection from 642.
Visitor's First Name Review Text Field (832):
   Displays visitor's saved values for 624.
Visitor's Last Name Review Text Field (834):
   Displays visitor's saved values for 626.
Visitor's E-Mail Address Review Text Field (836):
   Displays visitor's saved values for 628.
Visitor's Main Phone Review Text Field (838):
   Displays the visitor's Main Phone Number and saved from fields (630, 632, 634).
Visitor's Alt. Phone Review Text Field (840):
   Displays the visitor's alternate phone number saved from fields (634, 636, 638)
   If 634 contained no visitor input.
      840 is displayed as “N/A”.
Visitor Agent's First Name Review Text Field (842):
   Displays visitor's saved value for 800.
Visitor Agent's Last Name Review Text Field (844):
   Displays visitor's saved value for 802.
Visitor Agent's Brokerage Review Text Field (846):
   Displays visitor's saved value for 804.
Visitor Agent's Office Address Review Text Field (848):
   Displays visitor's saved value for 848.
Visitor Agent's Office Town, State, and Zip Code Review Text Field (850):
   Displays visitor's saved values from 808, 810, and 812.
      No saved value displays “N/A”.
Open House Discovery Review Text Field (852):
   Displays the visitor's saved value for 810.
      No saved value displays “N/A”
Back Button (Rep'd Data Review) (854):
   When selected:
      The program navigates back to “Rep'd Data Form” (FIG. 30)
Finish Button (Rep'd Data Review) (856):
   When selected:
      The saved visitor entries displayed elements 800-857 are applied to their assigned fields within a “Visitor Data Profile” and added to 446.

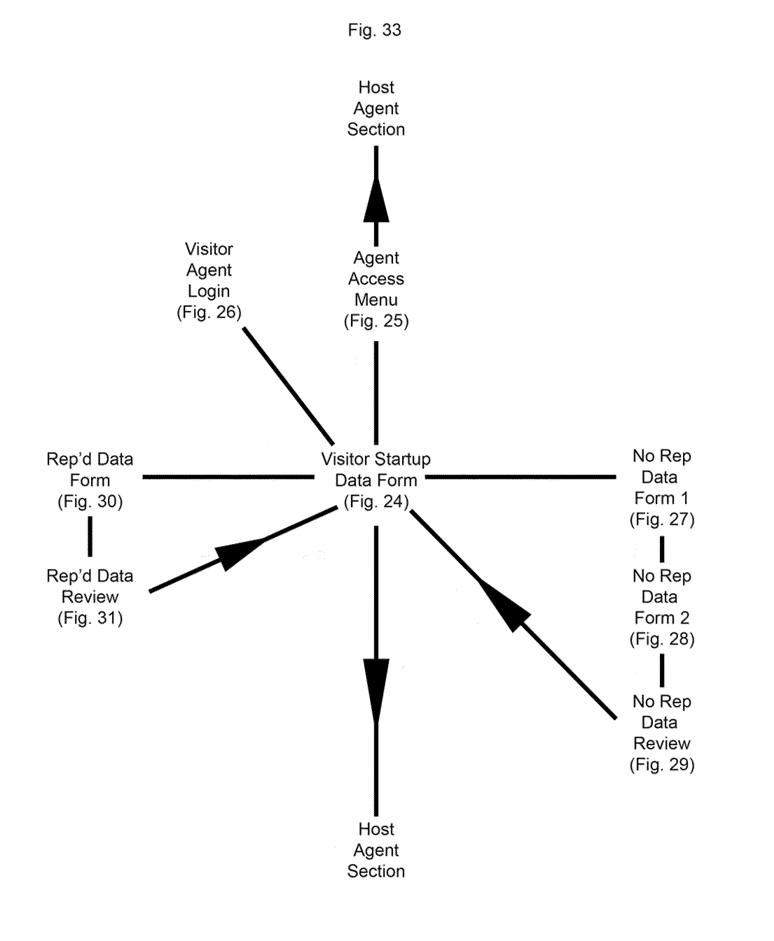

Now referring to FIG. 32 a navigational menu chart of the Host Agent Menu structure is shown. Each menu location has a ‘FIG. xx’ number beneath the menu text for reference to the figures. For example the Host Agent Menu in the central area of the diagram refers to FIG. 1 and the Host Agent Menu has multiple navigational links. From the Host Agent Menu, the Agent can navigate by clicking his mouse on different portions of the GUI to one of the other menus.

Starting at the 1:00 o'clock position of the Host Agent Menu and traveling clockwise around the diagram, these links are: 1) Visitor Input Section, 2) Managers, 3) Options, 4) Exit Options, 5) Data Collection, 6) More Info, 7) Reset Program Defaults, and 8) Registration Information. From each of these locations, other navigational links are shown. Thus to get from the Host Agent Menu to the Client Profile (located in the lower right hand side of the Figure), one must navigate to Managers/Session Manager/Client Database/Client Profile. This structure is useful in understanding the invention and also for modifying the structure in different embodiments so as to accommodate various corporate customer requirements. It should be understood that this structure is easily modifiable to either add/delete or modify existing or additional menu functions.

Now referring to FIG. 33 a navigational menu chart of the Visitor Startup Data Form menu structure is shown. Again each menu location has a ‘FIG. xx’ number beneath the menu text for reference to the figures. For example the Visitor Startup Data Form in the central area of the diagram refers to FIG. 24 and the Visitor Startup Data Form has multiple navigational links. From the Visitor Startup Data Form menu location, the Visitor can navigate by clicking his mouse on different portions of the GUI to one of the other menus. Starting at the 12:00 o'clock position of the Visitor Startup Data Form menu location and traveling clockwise around the diagram, these links are: 1) Agent Access Menu, 2) No Rep Data Form 1, 3) Host Agent Section, 4) Rep'd Data Form, and 5) Visitor Agent Login. Note the ‘arrow heads’ on certain links. This indicates a one way path between menu locations. Thus one cannot navigate directly from Visitor Startup Data Form to No Rep Data Review, but the converse is true because it is a return path only. From each of these locations, other navigational links are shown. Thus to get from the Visitor Startup Data Form to the No Rep Data Review (located in the lower right hand side of the Figure), one must navigate to No Rep Data Form 1/No Rep Data Form 2/No Rep Data Review. This structure is useful in understanding the invention and also for modifying the structure in different embodiments so as to accommodate various corporate customer requirements. It should be understood that this structure is easily modifiable to either add/delete or modify existing or additional menu functions.

Multiple Terminals/Web Browsers

For an event in which many visitors are expected, the program can be run in several stand alone terminals running separate programs in which the data is compiled into one database at a later time, or in a server/client mode with multiple data terminals available for visitors to register their information. The server may be physically present at the open house or it may be networked electronically over the Internet. Other methods such as a modem link via cell phone may be used to link the server to the local clients. The registration process can also be presented via a web browser such as FireFox or Chrome whereby the database is located at the server of the URL.

Multiple Operating Systems/Electronic Devices

The software can run on any common operating system such as Windows, Mac OS X, Linux, Chrome, and Android OS.

Electronic Registration

At large events, the organizer may wish to alleviate the burden of a visitor sitting and typing in his information. Electronic ID cards may be issued prior to the event to the registrants and they only need to swipe their card upon arrival to input all the required registration information. Other methods of electronic registration may be used such as RFID, bar codes, or cell phones with RFID chips may be used for easy, fast electronic registration.

Mobile Devices

The invention may also run on mobile devices such as an iPhone, iPad, other smart phones or electronic tablets. The software needs only to be ported or recompiled for these devices. Global Positioning System devices, aka ‘GPS’, which are in most automobiles today may register for an open house and provide navigational directions as the visitor drives to the location of the open house. The GPS interface can further provide registration information back to the Host Agent via its data link, whether satellite, Blue Tooth or USB.

Advertising

The invention can also provide other important referral services to the potential buyer. For example any buyer who has signed a purchase/sale contract is in need of timely services from a variety of professionals such as attorneys, insurance agents, home inspectors, well inspectors, water quality inspectors, septic inspectors, and title agents for example. The seller may also be in need of professional services of an attorney or contractors to fix or repair defects discovered during the closing process.

Many local businesses are also looking for ways to make contact with new neighbors in their service area. The Open House database can be linked with an advertiser database so as to provide information or services as requested by the potential buyer or the data can be sold to the local businesses.

While the present invention has been illustrated and described with reference to exemplary embodiments thereof, various modifications will be apparent to and might readily be made by those skilled in the art without departing from the scope and spirit of the present invention. Accordingly, it is not intended that the scope of the claims appended hereto be limited to the description as set forth herein, but, rather, that the claims be broadly construed.

I claim:

1. A method for creating an electronic database of potential real estate buyers comprising the steps of:
providing a computing system having an electronic interface with a visual display;
said computing system further providing mechanical means for inputting data by a buyer, and providing an electronic storage medium to store said inputted data by the buyer;
displaying data fields on the visual display;
capturing and storing data inputted to the data fields by the buyer; and
storing the data in the electronic storage medium;
whereby a potential real estate buyer enters his personal information into the computing system for storage in the electronic database.

2. A method as in claim 1 and further including the steps of:
providing administrative functions to a real estate agent;
providing electronic and printable reports to the real estate agent; and
providing an automatic email function facilitating an agent's message to the buyer

3. A method as in claim 2 and further including the steps of:
matching a set of buyer preferences against a second database of real estate listings and producing a match list;
communicating the match list to the buyer;
setting and communicating follow up alerts to the real estate agent for the buyer.
